(19) United States
(12) Patent Application Publication
(10) Pub. No.: US 2022/0234336 A1
(43) Pub. Date: Jul. 28, 2022

(54) SOFTBOOTS AND WATERPROOF/BREATHABLE MOISTURE TRANSFER COMPOSITE AND LINER FOR IN-LINE SKATES, ICE-SKATES, HOCKEY SKATES, SNOWBOARD BOOTS, ALPINE BOOTS, HIKING BOOTS AND THE LIKE

(71) Applicant: SOLID WATER HOLDINGS, Farmington, ME (US)

(72) Inventor: Baychar, Farmington, ME (US)

(21) Appl. No.: 17/666,738

(22) Filed: Feb. 8, 2022

Related U.S. Application Data
(63) Continuation of application No. 15/693,733, filed on Sep. 1, 2017, now abandoned.
Application No. 15/693,733 is a continuation of application No. 14/020,970, filed on Sep. 9, 2013, now abandoned.
Application No. 14/020,970 is a continuation of application No. 11/526,594, filed on Sep. 26, 2006, now abandoned.
Application No. 11/526,594 is a continuation of application No. 10/757,454, filed on Jan. 15, 2004, now abandoned.
(60) Provisional application No. 60/440,034, filed on Jan. 15, 2003.

(51) Int. Cl. B32B 27/06; B32B 5/32; B32B 5/24; B32B 5/18; B32B 27/18; A43B 5/04; A43B 7/12; B32B 5/22; A43B 1/00; A43B 3/00; A43B 23/07

(52) U.S. Cl. CPC B32B 27/065; B32B 2307/7265; B32B 5/245; B32B 5/18; B32B 27/18; A43B 5/0405; A43B 7/125; B32B 5/22; A43B 1/0045; A43B 3/0084; A43B 23/07; Y10T 428/249981; Y10T 428/249987; Y10T 428/249953; B32B 2437/02; Y10T 428/24331; B32B 2305/38; B32B 2307/7145; B32B 2307/724; B32B 5/32

(57) ABSTRACT

The soft boot and liner includes moisture transfer system that includes an inner fabric layer carefully selected from technically advanced fabrics. A series of layers are provided outside the inner liner including foam material layers, spacer fabrics and breathable membranes, in various orders. Encapsulation technology and waterproofing are used as well. The outer fabric layer is also capable of working with the other layers to promote the transfer of moisture. Frothed foams and flocking with fibers are further characteristics of the present invention. The moisture transfer system is incorporated into a soft boot or skate or as a removable liner for a shell boot. Numerous other modifications and applications are disclosed.

### FIELD OF THE INVENTION

The present invention relates to composite materials, removable insert liners and completed product constructions with an non-removable liner used in a variety of application. For example, the liner of the present invention may be employed in a variety of applications including in-line ice or hockey skates (shell and soft boot) and the like. This liner system composite may be utilized for all weather boots and alpine and hiking applications. The liner is breathable, transfer moisture and waterproof to increase comfort for the skater. The liner may contain thermal fibers, thermal PCM encapsulated molecules or fibers and/or a silica, acrylic, polyester fiber based polymers microspheres or the like containing air, polymers or liquid fibers that aids in cool or thermal regulating temperatures during performance and are capable of absorbing an electrical charge. The microsphere encapsulating the air, polymer or electrically sensitive to thermal absorbing material may be constructed of a inherently conductive polymer such as those created by the Polymer Research Institute in New South Wales, Australia.

### BACKGROUND OF THE INVENTION

Various types of liners are known in prior art. These liners are designed to provide certain levels of comfort and durability. Furthermore, in-line skates are also well known in the art as evidenced by U.S. Pat. Nos. 5,340,132; 5,397,141; and 5,437,466. Of these patents, only U.S. Pat. No. 5,437,466 discloses what is commonly referred to as a “soft-boot”. In other words, the shoe body is made of a soft, pliable material. General statements are provided about the materials used for the shoe body, but not in great detail.

However, the liners in ice hockey and in-line skates, as well as snowboard boots, etc., known in the art do not provide the advantages realized by the present invention. With the art of hockey and in-line skating becoming increasingly recreational, numerous categories of skaters are developing in large numbers. The present inventor has recognized the problems faced by the aggressive and the recreational categories of skaters and has developed a liner to overcome such problems.

There is an ongoing need for comfort, moisture transfer, breathability, and support for both removable liners as well as non-removable hockey and soft boot liners. In prior removable liner design, the conventional liner is often constructed with rigid, non-breathable outer materials such as vinyl's, foams, and nylons. The inner liners have been leather, nylon, or polyester blends which extremely limited the ability to breathe or wick moisture away from a skater's body. These materials have prevented the foot from breathing adequately. In the case of “shell boot” skates, the plastic material that forms the outer shell boot structure holds the heat and moisture inside the boot. As a result, the lining becomes saturated with sweat which adversely affects the skater's comfort and performance level. This problem is even worse with the aggressive hockey skaters whose needs for proper ventilation are even greater.

### SUMMARY OF THE INVENTION

An object of the present invention is to provide a lining system employing a cooler, warmer, drier and more breathable liner that meets the needs of each individual skater. Accordingly, the liner of the present invention can be accommodated to the needs of skaters of various skill categories by permitting the inner liner material, which is against the foot, to vary in fiber content and construction.

This object of the present invention is realized by providing a lining system having lining materials which act as a moisture transfer system and poses inherent moisture transfer polymers fibers and absorbent natural and synthetic fibers. The fibers may be combined in knits, wovens, nonwovens or in a combined construction of two or more constructions. An example of a combined construction is a warp-knit fabric such as such as the SENSITIVE Fabrics. Moisture vapors are transferred through the liner from one side to the other side by a multi-layered technically engineered fiber and foam system. In several composite systems the technically nonwoven fibers replace the foam. This is accomplished by utilizing certain materials in a manner determined by the inventor after considerable experimentation and effort. The details of the specific materials as used in the combination are disclosed in the Detailed Description of the Preferred Embodiments.

The moisture transferring lining system of the present invention overcomes the problems in the prior art lining systems and liners and meets the needs of even the most aggressive skaters.

Various other objects, features and advantages of the present invention will become readily apparent in view of the following detailed description of the preferred embodiments in conjunction with the drawings.

### BRIEF DESCRIPTION OF THE DRAWINGS

FIG. 1 illustrates a first portion of the liner according to a first embodiment of the present invention.

FIG. 2 illustrates a second portion of the liner according to a first embodiment of the present invention.

FIG. 3 illustrates an example of the liner according to the first embodiment if the present invention.

FIG. 4 illustrates the liner shown in FIG. 3 as applied to an inline skate.

FIGS. 5(a) and 5(b) illustrate a sole portion of a shoe constructed according to a preferred embodiment of the present invention.

FIGS. 6 and 7 illustrate a tongue portion of a shoe constructed according to the first embodiment of the present invention.

FIG. 8 illustrates a more detailed view of the liner portion used for the tongue of FIGS. 6 and 7.

FIG. 9 illustrates a portion of the liner used in the upper cuff area.

FIG. 10 illustrates the travel of moisture through a reticulated foam then a flexible mesh and into and through a breathable membrane according to the first embodiment of the present invention.

FIG. 11 illustrates the toe portion of a shoe according to a preferred embodiment of the present invention.

FIG. 12 illustrates an overall drawing of a snowboard boot, soft alpine boot, alpine or hiking boot which will incorporate the lining material of the present invention.

FIGS. 13 and 13A illustrate an insert for an in-line skate or hockey skate with a first portion enlarged.

FIGS. 14 and 14A illustrate another embodiment of an insert for an in-line skate or hockey skate with a second portion enlarged.

FIGS. 15 and 15A illustrate another embodiment of an insert for an in-line skate or hockey skate with a third portion enlarged.

FIGS. 16, 16A and 16B illustrate an insert for a soft-shell alpine boot with first and second portions enlarged.

FIGS. 17, 17A and 17B illustrate an insert for a soft-shell alpine boot with first, second and third portions enlarged.

FIGS. 18 and 18A illustrate a soft-shell alpine boot exterior shell composite with a first portion enlarged.

FIGS. 19 and 19A illustrate a soft-shell alpine boot exterior shell composite with a first portion enlarged.

FIG. 20 is a polymer shell for a hockey skate including a moisture transfer liner.

FIG. 21 illustrates soft-shell in-line skate or the like exterior shell composite.

FIG. 22 illustrates a cross-section of a deep groove fiber.

### DETAILED DESCRIPTION OF THE PREFERRED EMBODIMENTS

The following detailed description of the preferred embodiments of the present invention is undertaken in connection with the drawings. This description, while undertaken with respect to the disclosed embodiments, is intended to enable a variety of different applications and slight modifications which form a part of the present invention. More specifically, many of the materials used in this lining system have been developed relatively recently, and in many cases are still being modified and improved.

Where possible, tradenames of specific products have been used to assist in the understanding of the invention. The lining system according to the present invention can be easily adapted to accommodate further developments currently envisioned are set forth below.

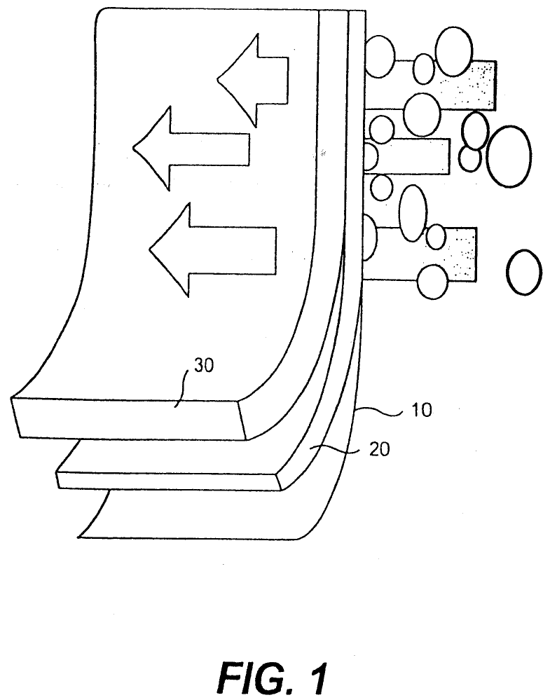

FIG. 1 illustrates a portion of the liner, or lining system, according to a first embodiment of the present invention. As shown in FIG. 1, a first foam (20) is provided between an inner liner (10) and a second foam or nonwoven material (30). The inner liner (10) can be attached to the first foam material (20) by lamination, stitch, needled or ultra sonically bonded, or the like. The second foam (30) is a germicidal anti-microbial reticulated and/or hydrophilic open cell foam and has a thickness of approximately 1/16 to ¼ inch. Optionally, the first and second foam layers, 20 and 30 may be a nonwoven and foam composite, a foam included in a nonwoven fiber or a foam with selected fibers flocked or needled fabric into either side. The first foam material is also preferably germicidal reticulated or open-cell hydrophilic and has a thickness of approximately 1/16-⅛ inch. Alternatively, the first and second foam maybe replaced by a technically engineered nonwoven fiber blend with or without open cell foam inclusive or an elastomeric composite or a foam and nonwoven fiber composite. A technically engineered nonwoven spacer fabric with natural and/or synthetic fibers can be substituted in some performance categories and be utilized in layers 20 and 30. The moisture transferring nonwoven or nonwoven and foam layers are combined by needling, lamination, ultrasonic bonding, flocking or the like to the back of the inner lining fabric. The spacer fabric may also be combined with the nonwoven composite with or with out foam in the same manner as mentioned above.

All the nonwovens in this invention are selected for the inherent ability to transfer and/or absorb moisture and may have anti-microbial silver fibers by Foss, Static or the like added to the blend. In a number of options the fibers included in the inner lining material, or nonwoven top sheet are embedded in the foam and possess anti-microbial, thermal and conductive properties. All of the foam materials used in the present invention are assumed to be breathable, hydrophilic, open cell and their thickness variable. Depending on the application, some of the foam materials may not be the used and the thickness of any foam material or spacer fabrics that is used can be changed as needed. All the foams in this application may include Microsphere Technology. For example, a foam called Aquazone, Premium, VFI by Foamex, Comfortemp by Frisby, or Netsorb by Vita Olympic, CoFoam Hydrophilix, or Dri-z by Dicon, hydrophilic foam with nonwoven fibers or the like can be used. Preferably, the germicidal, anti-microbial hydrophilic, flocked fiber open cell hydrophilic foam or a reticulated foam is treated with a surfactant the increase the moisture transfer rate. These chemical friendly additives can be combined directly into the foam polymer or may be applied after the foam is created. A hydrophilic coatings such as that created by Ciba Specialty Chemicals (ULTRAPHIL), Wisconsin Global Technology or the like may be added to the foam matrix or nonwoven abutting the foam. The foam can be attached to a non-woven top sheet of synthetic or natural fibers. The fibers may be flocked into the foam or added to the liquid polymer. The preferably, nonwoven fiber selection includes wood pulp and cotton, corn, kapok, lyocel, acrylic, chlorofibre, acetate, wool, hemp, polypropylene, polyester, rayon, lycra or a combination thereof. This top sheet is designed to absorb and move moisture. The fibers have inherent moisture transfer and absorb properties and can be treated with a number of MVT surfactants or wicking solution such as Intera Technology, Ultraphil, Nano-Technology or the like. Cofoam, a hydrophilic foam treatment by Hydrophilix may be applied to the foam or nonwovens to increase the rate of transfer. Coolfix which is developed by Trend Technology, Wisconsin Global Technology or Feran Ice Process may be included in this nonwoven layers, fiber, fabric foam layers or combinations in this applications. The nonwoven top sheet construction may optionally be replaced by a knitted fiber construction. The nonwoven top sheet or knitted fiber construction may be utilized for a scrums on either side of a foam or thermal nonwoven. The selected nonwoven fiber or blend of fibers may be inclusive in the thermal nonwoven blend, the foam or a nonwoven wet-laid, spunbond or needle punch product may be inclusive in the foam. The nonwoven fibers in this application are extremely important and they selected for the abilities as stated previously to move transfer moisture, absorb, increase or decrease temperature and provide stability. They are both active and passive in their performance. The polyester fiber inclusive in the nonwoven top sheet, knitted layer or layers of the thermal composites is preferably a shaped fiber such as the 4-Deep Grove polyester fiber or a variation of the shaped polyester fiber preferably, manufactured by F.I.T Group or the like. A shaped (CCF) fiber by Clemson University or a Technofine polyester fiber by Gelanots may be an option in this layer. These technically engineered polyester shaped fibers provide channels for the moisture to travel along and transfer quick to the exterior surface. The shaped fabrics maybe combined with an active carbon compound such as that by Craghoppers or silca gel to which increase the absorbent factor. Response Technology by Craghoppers is an option in this application for the inner lining polyester fibers and nonwoven and or foam composites. A selection of shaped natural and synthetic fibers as well as the polyester such as corn, acrylic, acetate an the like be included or in any layer in moisture transfer system. The elastomeric cellular composite referenced in the U.S. Pat. No. 6,074,966 may include the selected nonwoven and shaped fibers discussed previously. Optionally, the elastomeric composite may be used in place of the nonwoven top sheet on either side of the foam or thermal nonwoven or in place of the selected foam. In some performance categories the elastomeric composite maybe mechanically or ultrasonically bonded to the inner lining material abutting the foam, nonwoven or thermal nonwoven. The elastomeric composite contains synthetic and natural fibers and foam. These fibers may be treated with wetting solutions and/or hydrophilic foam such Cofoam as that by Hydrophilix Inc. US application 09-823-129 The elastomeric may be applied to the thermal nonwoven on either side or be mechanically or ultrasonically bonded to the thermal nonwoven. The elastomeric composite may be attacked or included in any layer in the moisture transfer system or may be any layer in the moisture transfer system excluding the exterior shell fabric.

The Cofoam or the like may be used as the selected foam in the elastomeric composite or be applied to any layer in the moisture transfer system. Cofoam may be used in place of the selected open cell foam or in combination with any layer in the moisture transfer system. The Cofoam may be combination with the thermal blend by Foss Manufacturing Dupont thermal nonwoven such as Thermolite, Ultrathin or with 3MM thermal nonwovens such as Thinsulite, nonwoven by Millennium or the like.

The nonwoven top sheet may be a dry-laid, wet laid, melt blown, spun bond or a needle punch product. The select fibers, fiber construction and treatment of the nonwoven top sheet is a key element in the moisture absorption and transfer properties in the system. The nonwoven may or may not require a wicking solution or treatment. The product category and performance level determines the selection of treatment and the fiber or combination of is a wet laid apertured nonwoven top sheet.

The selected non-woven top sheets are manufactured by DuPont (Sonatra Technology non-woven), Alhstrom Nonwovens, Dexter Synthetics, Freudenburg Nonwovens, Veritex, Nordlys, or the like. All nonwoven fibers in this application possess either active or passive moisture transfer abilities or both. The nonwoven may have polymer or silca microspheres or encapsulated PCM technology added with various fibers.

The preferably construction s optional to cooling and/or heating properties. The Outlast melt spun fiber may be an option in this layer or in thermal nonwoven layer. In some options the nonwoven fibers in the top sheet may be wrapped by another fiber or coated with a hydrophilic foam. The foam and fiber composite, nonwoven, fabric or the elastomeric composite may be coated with a hydrophilic foam such by Hydrophilix or treated with Ultraphil, Coolfix or the like to increase the MVT function and the cooling or thermal application. Optionally layer 20 may be eliminated when the hydrophilic foam, Cofoam by Hydrophilix or the like is applied to the back of the inner lining fabric or material or to the abutting nonwoven. In fact the Cofoam or the like may be substituted for any foam layer in this application creating extreme thin lining or outer lining moisture transfer composite. The inner lining fabric coated with Cofoam abutting the nonwoven or the nonwoven coated with Cofoam abutting the inner lining material may abut a spacer fabric, a cellulose material by Fox Run, a foam and polymer mesh composite or the outshell fabric for use in several of the defined categories discussed in this application.

However, in a number of categories the nonwoven abutting the inner lining fabric or material in layer 10 or foam in layer 20 is a thermal spun-bond, melt-blown or a needle punch product. The preferable thermal nonwoven is a needle punch product by Foss manufacturing containing a blend of deep groove polyester fibers, silver fibers and natural or synthetic fibers. The Foss Composite is constructed of a number of layers and fibers such lyocel, PVA, silver polyester or a blend needled together with or without foam. Alternatively, The Foss composite may be constructed with a nonwoven thermal by Dupont such as Ultralite, Themolite or the like or the Foss composite may have a 3 mm nonwoven included such as Thinsulite 100, 200, 300 or the like. These composites transfer moisture and are thermal regulate the product by increasing or decreasing the fiber contain or treated fibers. Of course Dupont, 3MM and Foss nonwovens may be used in place of the Foss composite in any layer between the inner material and out shell fabric.

The selected nonwoven fibers optionally may be flocked to the back side of the inner lining material, the exterior shell fabric or to any foam, foam composite such as the elastomeric composite, breathable membrane, thermal or thermal composite. Fibers may be flocked as well to the foam inclusive of the nonwoven fibers, nonwoven sheet or polymer mesh. The flocked fiber or blended fibers optional may be flocked to both sides of the nonwoven, breathable membrane, breathable adhesive or open cell foam. The thermal nonwoven such as that by Dupont or 3MM optionally may be attacked to the foam inclusive of the fibers or polymer mesh or both.

The aperture nonwoven alternatively may be mechanically bonded to the foam layer 20, 30, 50 on one or both sides. Optionally, the apertured foam composite combination may be combined with the thermal nonwoven, nonwoven composite or flocked composite blend. In some options the nonwoven, foam and polymer mesh layer may be needled or ultrasonically bonded to the thermal nonwoven. The preferred hydrophilic foams are developed by Dicon Foams, Vita Olympic, Hydrophilix, Foamex foams distributed by Rogers Corporation or the like.

The foam or foam and nonwoven laminated or welded combinations in layer 20 or 30 as previously suggested maybe optionally replaced by a needle punched nonwoven with or without foam preferably the Foss composite or by the elastomeric composite having a foam inclosing a non-woven fiber formed in a single process.

The inner liner fabric is a moisture transfer fabric capable of wicking moisture. The inner liner 10 is preferably constructed using specific fabrics possessing certain desired characteristics, but with varying fiber compositions. A list of fabrics which can be employed depending upon the individual needs of their application as well as the individual needs of each skater are provided below. These fabrics may either be used individually or in combination. The following inner moisture transfer liner 10 materials may also be replaced by new moisture transfer fabrics with similar characteristics as the technology on the market develops for this invention. The technically engineering of several fibers constructions and combinations is employed in this application. A flocked fiber blends made be added to the back of the inner lining or shell fabric material.

The multi-faceted shaped polymer based synthetic and natural fiber blends lend endless possibilities in construct to the first layer. These new shaped fibers increase moisture transfer, cooling and heating applications and increase performance levels.

The first fabric or nonwoven is a moisture transfer material capable of wicking moisture. These fabrics and materials may be treated with wicking solutions to increase the moisture transfer rates. The inner liner 10 is preferably constructed using specific fabrics possessing certain desired characteristics. The fiber compositions and construction may vary with the products and performance needs.

A list of fabrics which can be employed depending upon the individual needs of each skater are provided below. These fabrics or nonwovens may be used individually or in combination. All fabrics or nonwovens in the first layer may be treated with a wicking solution such as Coolfix, Ultraphil or the like and must provide active as well as passive moisture transfer capabilities. Fabric or nonwoven construction, fiber selection and MVT surfactants and/or coating may be employed in multiple combinations in this first layer 10 to increase the transfer rate. Optionally the first layer is a multi-teared construction flocked or needled together. The first layer may alternative flock the fibers from the nonwoven in to the back fabric or nonwoven inner lining material or the foam or foam and nonwoven blend may be flocked or needled to the back side of the inner lining material. This multi-teared construction absorbs and transfer moisture and may be treated with a cooling microsphere or chemical option. The inner lining material contain an active carbon compound to increase the moisture transfer as well as shaped fibers.

The following inner moisture transfer liner materials may also be replaced by new moisture transfer fabrics with similar characteristics as the technology on the market develops for this invention.

The first fabric is an anti-microbial, anti-fungal polypropylene (also referred to as polyolefin) lycra blend (2%) with INNOVA fiber, or the like. INNOVA is a continuous filament fiber (manufactured by Coville, Deercreek fabrics.)

The second fabric is an anti-microbial, anti-fungal polypropylene, polyester or polyester blend having a polyester or cotton, corn or lyocel backing or the like (such as that manufactured by Coville, Inc.”. This fabric has the face of one fiber and the backing of another and may vary in composition depending on the performance level of the skater.

The third fabric is an anti-microbial, anti-fungal polypropylene/cotton blend with ALPHA fiber, or the like (such as that manufactured by Intex Fabric, Inc.)

The fourth fabric is a field sensor polyester with waffle weave construction (such as that distributed by Yagi & Co., Inc. and manufactured by Toray). This fabric is constructed to transfer moisture immediately away from the foot and performs best as the liner for the soft-boot in-line skate. Alternatively, a polyester material known as Aqua-Dry, distributed by Teijin Shojin can be employed or the like.

The fifth fabric is a Technofine polyester shaped fiber by Gelanots

The sixth fabric is 3×Dry process fabrics or by Schoeller

The seventh fabric is a two layered fabric by Feron Ice process on a synthetic or natural fiber or a blend of natural and synthetic fibers.

The eighth fabric or nonwoven is made from corn fibers or a blend of corn fibers with one or more of the following fibers, lyocell, acretate, PVA and polyester.

The ninth fabric is polyester fabric with an active carbon compound bonded to the polyester by a fabric Craghoppers

The tenth fabric group by Nano-Technology called Nano-Dry Fabrics

The eleventh fabric materials is a synthetic leathers preferably by Nextec of Italy, SISA or Clarino.

The twelfth fabric Technofine polyesters by Gelanots

The thirteenth fabric is a Dri-release fabrics by Optimer Performance fibers

The fourteenth fabric is Dri-line and Sphere Technology fabrics by NIKE

The fifteenth fabric is Polyguard guard by KOSA

The sixteenth fabric group is Dry-tech Comfort System fabrics by Westcot

The seventeenth fabric group is a the Thermal Pro Fabrics by Malden

The eighteenth fabric group is the Gore Windstopper N2S

The nineteenth group Polartec powerdry

The twentieth fabric is a fabric called Aquafil Dryarn by rhovyl in France and Italy.

The twenty-first fabric Sterling Performance fabric

The twenty-second fabric Dryline by Milliken

The twenty-third fabrics are Corn fibers and fabrics by Draper Knitting

The twenty-fourth fabric is Acrillian or Duraspun by Monsanto

The twenty-fifth fabric is a hydrophilic, anti-microbial Dri-Lex Baby Kid or perforated material (such as that manufactured by Faytex Corp.).

The twenty-sixth fabric is a polyester looped Terry (such as that manufactured by Fronfli Spundale Mills, Inc.).

The twenty-seventh fabric is a sueded/sanded polyester microfiber material (such as that distributed by Yagi & Co., Inc. and Teijin Shojin, Inc., Millken or Malden Mills).

The twenty-eighth fabric is an anti-microbial, anti-fungal Polar Tec Series 2000, which is a wickable, moisture transfer fiber, containing lycra, polypropylene, or the like.

The thirtieth fabric group are Sensitive Fabrics

The thirty-first fabric are polyester fabrics by Coville

The thirty-second nonwoven fabric is Evolon nonwoven by Freudenburg.

The thirty-third nonwoven wool blend by Foss Manufacturing

Any of these fabrics and nonwoven top sheets may have the selected nonwoven fibers flocked to the back surface or may be laminated to a foam that has the nonwoven fibers flocked into the back of the foam.

All of these fabrics have good moisture transfer characteristics which prevent damage to a skater's foot by preventing excessive moisture build-up. The moisture transfer inner fabrics may vary in composition and structure in this liner system as fiber technology advances.

This application constructs the following inner lining composite constructions

As stated previously all inner lining materials and fabrics are laminated, needled, stitched, ultrasonically bonded or mechanically bonded to the abutting material, nonwoven or foam. The inner lining materials or fabrics may be selected from the previously list

The first is a inner lining fabric or material abutting an open cell, hydrophilic foam laminated or needled to a nonwoven material.

The second a inner lining fabric or material abutting a open cell, hydrophilic foam where the nonwoven fibers have been flocked into the back of the foam, inner lining fabric or breathable membrane between the inner lining material and foam.

The third is a inner lining material or fabric with an elastomeric cellular composite such as that referenced in the U.S. Pat. No. 6,074,966 mechanically or ultrasonically bonded to the inner lining material.

The fourth is a inner lining material or fabric abutting a open cell, hydrophilic foam with the elastomeric cellular composite mechanically or ultrasonically bonded to the foam layer on either side or on both sides.

The fifth inner lining composite construction is an inner lining material or fabric abutting a Foss nonwoven composite constructed of one or more of the following fibers polyester (preferably 4 Deep grove by F.I.T. or a variation), Lyocel or acetate, corn, wood pulp cellulose and silver fibers.

The sixth is a inner lining fabric or material with the foam and nonwoven fibers flocked into the back surface.

The seventh is an inner lining fabric or material abutting a foam. The foam is inclusive of a nonwoven layer or fibers.

The eighth is a inner lining fabric or material abutting a moisture transfer nonwoven spacer material. Variations of the inner lining composite are on going and are suggested in multiple combinations. The intent of the moisture transfer system is to provide a complete technical solution in a extremely thin increment to accommodate the comfort needs of the user.

All of the above composite options are presumed breathable and transfer moisture. The inner lining composite abuts another open cell hydrophilic foam, nonwoven composite of foam and nonwoven and/or a thermal nonwoven, a spacer fabric or polymer mesh and the exterior shell fabric and/or material, skeletal polymer shell or a combination of one or more. A breathable membrane may be insert between the exterior shell fabric and the nonwoven, spacer product, cellulose material, polymer mesh or foam layer.

In one option a combination of foam and nonwoven, a foam and a thermal nonwoven or a foam and spacer fabric or polymer mesh are positioned in layer 30 abutting a spacer fabric, cellulose material or exterior shell material. The above combinations suggested for use in the ice and hockey skates, protective gear, helmets and accessories such as gloves.

The moisture transfer characteristics of the inner liner composite causes moisture vapors to be passed from a skater's body through the inner liner 10 where it then comes into contact with the first foam material 20. The moisture vapors travel through the first foam material 20 and come into contact with the abutting nonwoven, foam, spacer or cellulose material 30. In some performance categories the aperture nonwoven may be eliminated. between layer 20 and 30 or the foam in layer 30 may be a spacer fabric or thermal nonwoven product or composite. The spacer fabric and thermal nonwoven are optional as well in layer 30 and are use to provide comfort and warmth. In the thinner applications such as in the hockey and ice skate, the inner lining composite abuts the outer shell fabric and polymer shell. The performance category determines the materials and combination of materials in layer 30.

In another liner option consists of an exterior shell fabric, a frothed open cell foam or free rise foam abutting a nonwoven or nonwoven thermal layer preferably by Foss Manufacturing, Dupont, 3MM or the like and the inner lining material. The foam may contain fiber and/or a polymer mesh. Phase change Technology may be added to the selected nonwoven, flocked fibers or composite or a nonwoven by Outlast, Frisby, Freudenburg or Wisconsin Global may be used abutting the exterior shell fabric material

As discussed above, first foam material 20 may be a cellular elastomeric composite comprised of a layer of germicidal anti-microbial open cell hydrophilic polyurethane foam such as Foamex foams (VPF, Aquazone), Dicon foams or the like and a non-woven top sheet. All of the foam material discussed herein are preferably polyurethane, although not specifically mentioned each time. The inclusive top sheet is preferably composed of wood pulp, rayon, corn, cotton, lyocel, PVA, silver fiber, polypropylene, polyester, or a combination thereof.

Alternatively, foam material 20 can be a foam that is separate from the non-woven top sheet and is attached to the non-woven top sheet by lamination, stitch bonding, or the like. The non-woven top sheet (when used) abuts the next layer of ¼″ reticulated and/or open cell hydrophilic foam, or second foam material 30. The second foam material 30 when used may also be a germicidal, anti-microbial, reticulated and/or open cell hydrophilic ⅛/¼″ foam such as Aquazone with or without surfactants, wicking solutions and/or PCM Technologies, Sphere Technology applied or Comfortemp. The first layer 20 or the second foam material in layer 30 may contain a moldable mesh such as that developed by Naltex or Conwed in some embodiments. The polymer mesh inclusive in the open cell foam or laminated to the open cell foam can be in applied to any foam layer in this moisture transfer system. The foam may also include a fiber or a group of fibers as well as the polymer mesh. The second foam material is preferably backed with a non-woven top sheet as mentioned above. In fact, any of the foam materials discussed herein can be backed by such a non-woven top sheet, but the non-woven top sheet is not absolutely necessary. Also, many of the foam materials are interchangeable depending upon specific needs of the skater. The non woven apertured top sheet is comprised of cotton, wood pulp, lyocel, silver fiber, PVA, polypropylene or polyester or a combination thereof.

The previous fibers may be flocked into the back of the foam layer 20, 30, or 50. A nonwoven top sheet layer, elastomeric composite or thermal nonwoven composite may be combined with the foam and flocked fibers or foam and flocked fibers and inner lining material.

One preferable embodiment for a hockey skate moisture transfer liner combines the inner lining material laminated to a foam with flocked fiber backing the inner lining or foam and a spacer fabric or polymer mesh and the exterior shell fabric.

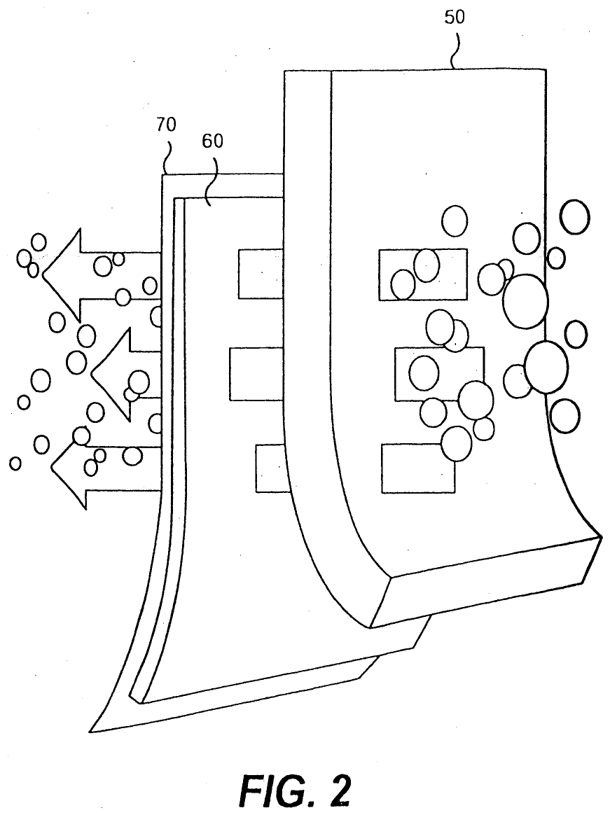

As shown in FIG. 2, a third foam material 50, which provides support and has similar characteristics to the second foam material 30 Layer. Layer 30 allows the moisture vapors to continue their movement to the outside and optionally the foam may contain a polymer mesh. The layer 50 is a slow recovery moldable foam (by Poron or Foamex), or a polyurethane reticulated and/or open cell hydrophilic anti-microbial foam or a spacer material that functions like a moldable foam and is composed of polypropylene and polyester. The spacer fabrics is formed in certain areas to take the shape of an ankle, heel pocket, and foot bones. Layer 50 is optional and is based on the needs of the product. All the spacer fabrics are engineered with fibers that increase moisture transfer. Layer 50 may abut layer 20 in some performance categories. An air bladder may also be added in the area around the ankle in place of the third foam or spacer fabric material. Layer 50 may be a combination of a moldable foam and spacer fabric shaped to aid in performance and support. The air bladder may be inflated by pumping the reflective grip 410 just under the pull tab. An air bladder may be added in the tongue area or in the cuff. Furthermore, spacer fabrics may also be used in place of the foam or bladder 50 in the tongue. The moldable polyester, polyamide, polypropylene spacer materials may be such as those manufactured by Muller, Schiebler, Peltzer or Fugafil or the like in varying combinations. The environmental acceptability of many foam materials is an important factor to consider when selecting the proper materials. Material 50 is positioned so as to allow the moisture to pass through into subsequent elements, such as waterproof/breathable membrane 60 and the outer shell 70, or an encapsulated outer fabric of the overall lining system. The outer fabric may also be treated with a waterproof film and may be combined encapsulated technology. The third foam, cellulose material or spacer material 50 can be designed to provide a well defined heel lift and heel pocket. The pocket may also contain a silicon gel, moldable foam, frothed foam, air or an open foam, nonwoven, or cellulose material with or without PCM'S. The pocket is optional and may be removable in some applications. This invention enables improved performance with the increased support around the heel, toe and ankle. The toe box is from top to bottom, wider and more flexible than in previous liners, specifically those described in U.S. Pat. Nos. 5,092,614, and 5,397,141. The laminated foams under the heel support the skater's lower back and allows for a comfortable stride. With this added comfort, the aggressive or recreational skier can achieve a higher level of continued performance.

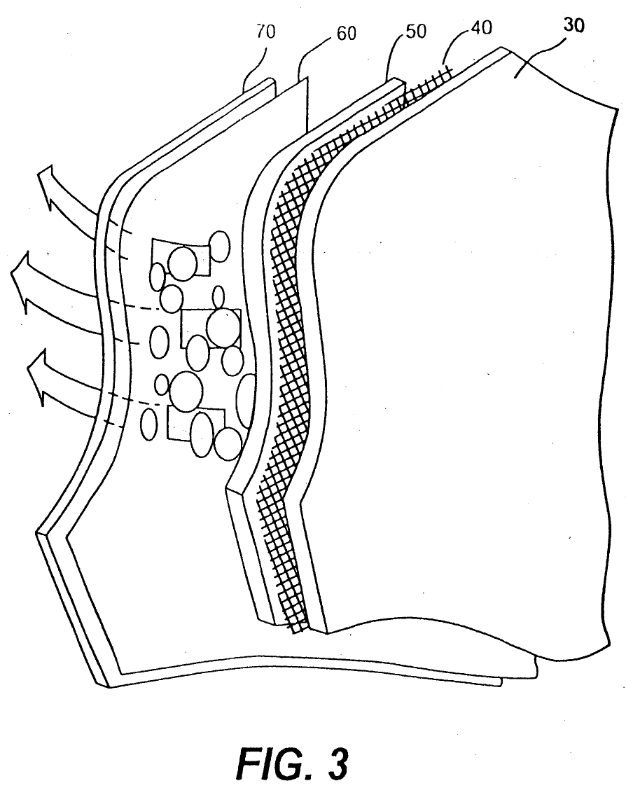

As shown in FIG. 3, between the supporting second foam material 30 and the third foam material 50 is a structural mesh 40 which can be a flex guard, for example, such as one manufactured by NALTEX or Conwed Plastics, or the like, that adds structural integrity to the lining system. This polymer mesh as discussed above may be included on or in any foam layer. A suggested combination for the ice and hockey skate would combine the polymer mesh in the foam abutting a thermal nonwoven or abutting the nonwoven composite by Foss Manufacturing or the like. The multiple layers of foam, and nonwoven increase rebound and comfort levels. The nonwoven and nonwoven anti-microbial silver fibers or the like fibers or anti-microbial treatment may be added in some performance categories to the foam and mesh composite.

A nonwoven thermal may be a Thinsulite, 3MM thermal nonwoven, Themolite, Dupont thermal nonwoven, Ssoftherm, or a Foss composite with or without foam. A shaped polyester, or synthetic fiber may be combined with a thermal nonwoven with or without foam. Alternatively, the nonwoven fibers suggested previously may be combined with the thermal or foam. The foam may be combined with the fibers, a polymer mesh or a combination in a number of performance categories. Optional the foam combined with the fiber, mesh or a combination may has fibers flocked to either side or both in some applications.

A moldable foam, spacer material, or gel or the like may also be used in place of this flexguard and foam combination or an air bladder. The moldable foam may or may not be a slow recovery foam by Rogers or the like. If it is not very breathable, it can be made breathable by puncturing. Alternatively, the moldable foam is preferably similar in construction to the second foam material, and can be a polyurethane reticulated and/or open cell hydrophilic anti-microbial germicidal foam approximately ¼ inch thick (for example Aquazone, Netsorb, Dri-z by Dicon, Comfortemp, or the like). A non-woven top sheet (with or without apertures) can be attached to the moldable foam. If a moldable foam or spacer fabric is used, then the second foam material may be omitted. Also, the moldable foam can be Aquazone.

As mentioned earlier, the third foam material 50 is preferably similar in construction to the second foam material, namely being either germicidal, reticulated and approximately 1/16″/⅛″ or ¼″ thick or being germicidal, hydrophilic, and open cell (for example Aquazone). This material is preferably laminated to a nonwoven top sheet (which may or may not be apertured) comprised of wood pulp, rayon, cotton, corn, silver fibers lyocel, polyester, polypropylene, or a combination thereof. The nonwoven or knitted top sheet maybe applied to either side of the foam, spacer fabric or thermal nonwoven to increase moisture transfer. The fibers selected for the nonwoven top sheet may be flocked to the any fabric, nonwoven, foam, breathable membrane or spacer material in this liner system. The top sheet when used abuts the waterproof/breathable membrane 60 and the polymer shell or a combination of fabrics and/or materials and polymer. The nonwoven top sheet may abut an encapsulated outer shell fabric combined with polymer shell or a combination. An example of a combined fabric and polymer shell is the Rossignol soft alpine boot or the K2 in-line skate.

The suggested nonwoven top sheet fibers maybe flocked into the foam, combined with the thermal, inner lining material, elastomeric composite, breathable membrane or spacer fabric. The nonwoven top sheet may be mechanically bonded to the thermal nonwoven, foam or thermal composite on one side or both to provide an increase rate of moisture transfer.

The outer shell fabrics may also be treated with waterproof film and finishes or encapsulated fibers or fabrics in some performance categories. The waterproof encapsulated outer shell fabrics eliminates the need for a waterproof/breathable membrane in most categories. However, the a breathable membranes such as Gore, eVent or the like maybe combined in this application with encapsulation, finishes, films, or coating in some performance categories. In fact composites of flocked foams fibers or fabrics or nonwoven moisture transfer thermals maybe abutting a breathable membrane like Gore, eVent Aquador or membranes by Brookwood or the like. The outer fabrics may also be constructed to repel water with breathable membranes, encapsulated fibers or fabrics, a breathable film or coating. The selected coating and films are breathable and may be use independently or combined with a breathable membrane in some performance categories. The waterproof encapsulation is preferably by Nextec. Nextec is the owner of the Canadian patent CA 1338232, 593680 applications and the U.S. Pat. Nos. 4,666,765, 5,004,643, 5,418,015, 5,209,965. Encapsulation by Nextec, Toray, ASF and others may be developed in any layer in this moisture transfer system, Preferably the encapsulation is applied to the outer shell fabric listed in this application. Encapsulation by Toray, ASF and others wraps the individual fiber or thread in a polymer base coating. Encapsulation by Nextec coats an internal layer creating a silicon coated woven fabric substrate. (U.S. Pat. Nos. 5,418,051 or 5,209,965). Encapsulation allows the moisture vapor to travel around and through the woven, knitted, nonwoven shell fabric, material or elastomeric or combination.

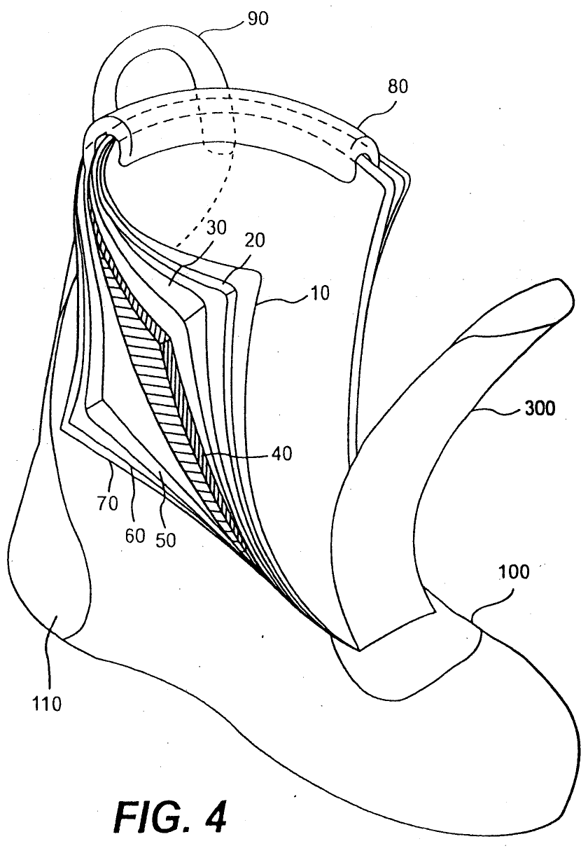

The moisture vapor continues from the second foam material 30 through the meshor spacer if applied 30, and on through the third exterior foam material 50 or outer shell material. If the spacer fabrics or thermal nonwovens are used then the outer layer of foam material 50 may be eliminated in certain performance conditions. The moisture vapors are then passed through waterproof/breathable membrane 60 or the encapsulated other fabrics, or the like. If the outer fabric is encapsulated, then the moisture vapors pass around the encapsulated fibers and onto the surface fabric. If the liner employs a waterproof/breathable membrane, then the moisture vapors are absorbed into the membrane and passed through to an outer layer of fabric 70, as shown in FIG. 4. The waterproof/breathable membrane 60 can be selected from a variety presently available on the market.

Those under the tradenames Aquador, Entrant Dermizax, Witcoflex, Harrison Technologies membranes, eEvent, Super Dry Film, Windstopper membrane, eEvent, Dry comfort, Outdry, Active comfort, Sympatex Windler, Sympatex Elastic, Drytrail, Eclipse, Endurance, Vapex, 2000/Plus/Standard1300, Seco-Tec, Dermizax, Thintech, Lay-tek, Witcoflex Ecodry (by Baxenden Chemical), TX-1540, Outdry, Gore membranes, PTFE by Tetratec are currently being considered. However, the membranes currently being considered is Aquador, eVent and Harrison Technologies. A breathable membrane may be combined with a thermal nonwoven such as Thermolite, Thinsulite, Ssoftherm or the moisture transfer nonwoven and foam thermal disclosed in this application. Outlast fibers which regulates temperature may be combined in some options in the nonwoven Dupont products or other nonwoven blends or foam in this application. If the preceding foam layers are Comfortemp or have PCM Technology applied to the foam, then the Outlast fibers or membrane is eliminated. These waterproof/breathable membranes are ultra-thin, skin friendly moisture barriers that allow moisture vapors to escape while preventing outside water from penetrating. Outlast Technology is a Phase Change Technology contained in a membrane, a spun melt fiber or a coating and is manufactured by Gateway Technologies. Frisby Technologies which is a thermabsorb micro-encapsulation technology can adjust to temperature changes and is added to foam. PCM Technology can be added to any fiber, fabric, foam, foam composite, thermal, breathable membrane or flocked fiber blend in this application.

A number of patents have been issued to Triangle Research & Development Corp. disclosing the details related to the processes now being employed by Gateway Technologies and Frisby. For example, U.S. Pat. Nos. 4,756,958 and 5,366,801 are directed to fibers and fabrics with reversible enhanced thermal properties, respectively. The disclosures of these two patents are hereby incorporated by reference. Other patents assigned to Triangle Research & Development Corp., that are related by subject matter and have overlapping inventorship, include U.S. Pat. Nos. 5,415,222; 5,290,904; and 5,224,356. These patents are also hereby incorporated by reference.

Another patent, U.S. Pat. No. 5,499,460, which has overlapping inventorship with the above-mentioned patents, is directed to a moldable foam insole with reversible enhanced thermal storage properties. The disclosure of this patent is hereby incorporated by reference, and is illustrative of one type of moldable foam that can be used as mentioned herein.

Also shown in FIG. 4 is a protective rim or cuff 80, preferably made of neoprene covered by lycra. Also, a germicidal hydrophilic open cell and/or reticulated foam by Foamex or Vita Olympic, for example, can be used. A pull tab 90, preferably made of nylon, is connected to the protective rim 80. An abrasive protective material 100 is provided adjacent to a tongue 300. Another abrasive protective material 110 is provided around the heel portion of the shoe. Abrasive protective material 110 is supplied by Schoeller or DuPont, for example.

The outer layer of fabric 70 of the lining system has 200 to 6000 denier strength and is made waterproof by a membrane, encapsulation technology, or a waterproof film. If the waterproof film is applied to the outer fabric, then the membrane or encapsulation technology may be omitted. Encapsulation technology is being utilized by a company called Nectex, Inc. US (U.S. Pat. No. 5,004,643) (U.S. Pat. No. 4,666,765) or Toray, Inc. (a Japanese company or the like). The breathable membranes preserve the outer layer of fabric 70 and perform as a waterproof barrier for the liners. If the encapsulation technology is applied to the outer layer of fabric 70, then the breathable laminate membranes need not be used. The encapsulation technology regulates the degree of waterproofing and breathability of the outer fabric shell by encapsulating an internal layer of fibers within the outer fabric. When the of encapsulated fibers layer is closes to the fabric surface, the fabric is very waterproof and less breathable. If the layer of encapsulated fibers are in the middle of the outer shell fabric, then the fabric is equally waterproofed and breathable.

The outer layer of fabric 70 is a combination of extremely durable, lightweight materials, Kevlar/Keprotec products 13207, 13624, 6500, 14705, 65563, 13602, 13408 (manufactured by Schoeller, Inc.), the Schoeller spirit line 14138, 14118, 14140, 14120, 14124, 14126, 14128, 14134, 14642, 14643, 14641, 14645, 14636, 14637, 14122, 14132, 14640, Kelvar and nylon Fabrics by Nam Liong, nylon supplex (such as that manufactured by Travis Textiles, Inc. or Blank Textiles, Inc.), nylon Cordora (manufactured by Schoeller, Inc.), other Cordoras (manufactured by Schoeller or DuPont), maxus 6-ply (manufactured by Blank Textiles, Inc.) or Starlite Dri-lex nylon fabric (manufactured by Faytex Corp.), Mojave or Tudor (both manufactured by Travis Textiles, Inc.), Microft (manufactured by Teijin), Entrant Gil and Dermizax (both manufactured by Toray), Gymstar Plus (manufactured by Unitika), Ultrex High Performance Fabrics (manufactured by Burlington, DuPont, Schoeller, or the like), Nextec synthetic leathers and nonwovens or the like or the like, or other fabrics having similar characteristics as these new products. Nonwovens by Sontara Technologies or the like can be used in combination with outer fabrics and are not to be confused with the nonwoven top sheets attached to the inner foam materials. Instead, this is a high abrasion, moisture transfer, absorbent material that is a spun lace (polypropylene) moisture management product, such as Sontara Technology nonwoven, manufactured by DuPont, or nonwoven by Freudenburg for example.

Selecting the proper materials depends upon the needs of each individual skater. The non-abrasive cool fabrics used in the inner liner of the present invention greatly reduce the possibility of trapped moisture, thereby protecting the foot from fungus growth and any damage. The more aggressive skaters need a moisture transfer liner that can remove large amounts of moisture continuously from the foot. These skaters often do not wear socks, and as a result, calluses, abrasions and blisters become commonplace. A wetting agent may be applied to any of the inner lining materials 20 to enhance the moisture transfer away from the foot. The anti-microbial anti-fungal polypropylene (polyolefin) fabrics quickly remove moisture away from the foot. Skin damage is minimized because the polypropylene fabric has a smooth, continuous surface. This fabric also prevents bacterial build-up which can cause foot odor and fungus.

The looped polyester terry blend or the like is an excellent wicking fabric and can remove moisture rapidly. A wetting agent by Witco, or the like, may be applied to enhance wickability.

The anti-microbial, anti-fungal Dri-lex nylon and nonwoven fabrics blends are sanded and soft. The material not only removes moisture away from the foot, but is also extremely comfortable and cool to the touch.

The polyester field sensor fabric or intera treated polyesters, polyester blends or the like works well with those individuals who prefer sports or recreational skating. This liner absorbs moisture immediately and is recommended for the soft boot inner liner.

Finally, polyester microfiber fabric is advantageous in that it is coot to the touch, smooth and wickable. A wetting agent treatment enhances wickability.

As a result of using this lining system, the skater continues to have a cooler, drier foot. The lightweight Kevlar, Starlite, and Cordura, or the like, outer liner materials are twice as durable as the former heavyweight nylons often used on the outer shell, but function as a softer feeling breathable outer surface and aid in the moisture transfer.

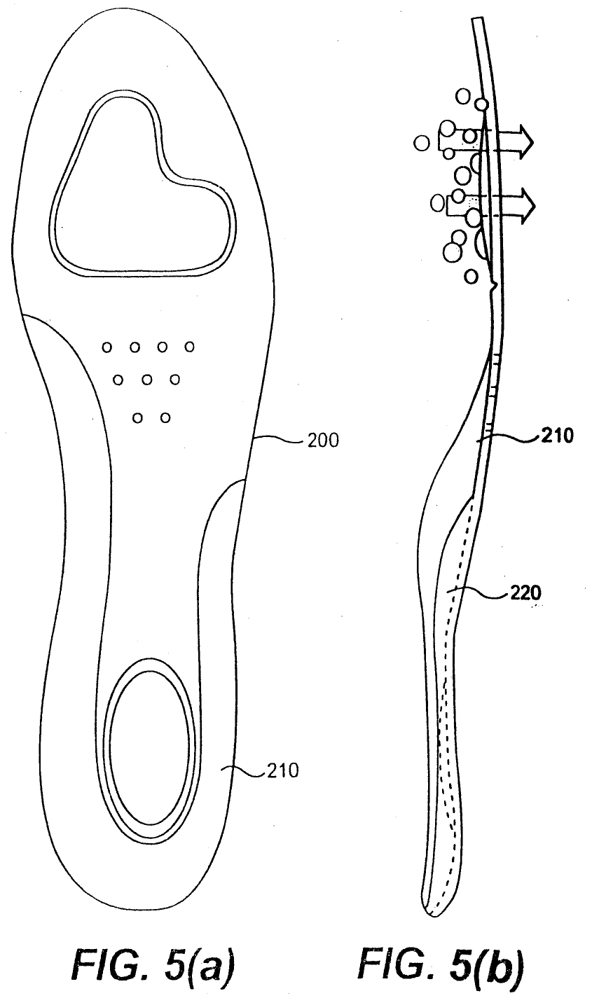

FIGS. 5(a) and 5(b) illustrate a sole portion 200 of a footpad covered with one of the selected fabrics such as cambrelle Dri-Lex nylon, evolon by Freudenburg, polyester blends or the like. Preferably, however, the foot pad is designed using a nonwoven, flocked fibers or Coville fabric. The top sheet is backed by Flocked fibers, a Foss nonwoven composite, a hydrophilic moldable nonwoven or foam. The sole insert footbed protects the foot from abrasion and friction burns. The inserted hydrophilic anti-microbial foam (an open cell moisture vapor transfer foam) or slow recovery punctured foam foot pad adds support and transfers moisture downward. The bottom portion of the foam is preferably provided with a nonwoven to sheet or flocked fibers as described earlier, a material called Saran@Climate Insoles by Fugafil or Sumuntez 1, 2 by Textel may also be used in place of the foam composite foot bed. The heel pocket foam or gel protects the back of the heel with a double layered reticulated and/or slow recovery moldable foam or a cellulose material. This cushion protector allows circulation in the heel. The anti-microbial silver fibers, polyesters, nylon fabric blends or nonwovens or the like, covers a molded hydrophilic open cell foam free rise or frothed foam or Foss composite 20 that supports the arch and insures the skater a comfortable stride.

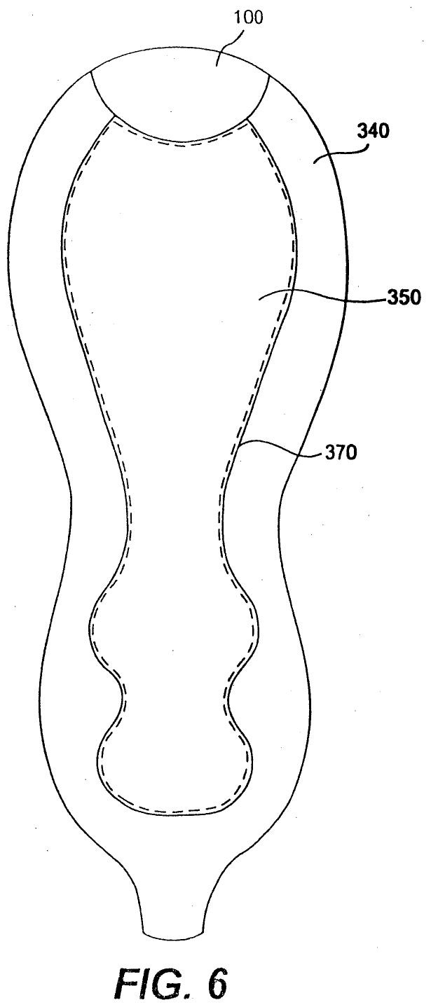

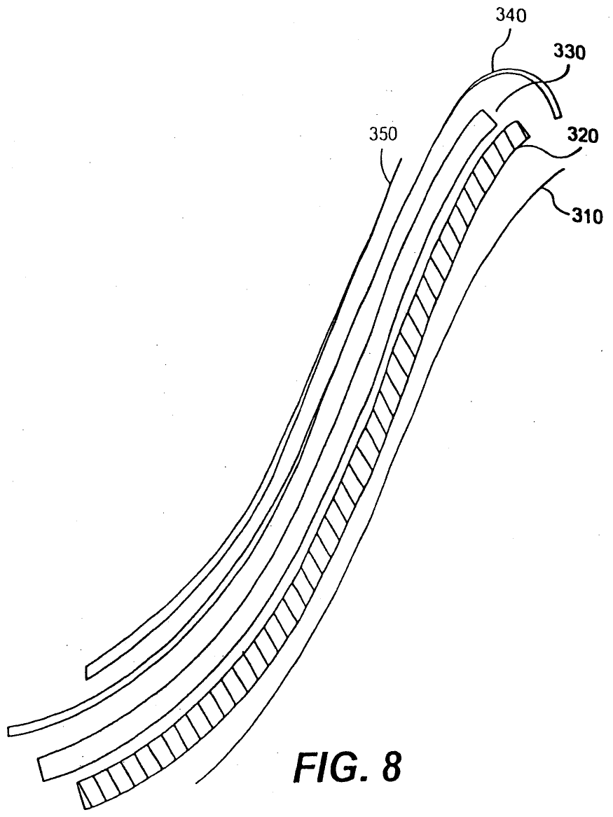

FIGS. 6, 7, and 8 illustrate the tongue 300 of the boot in more detail. The tongue is designed to add further comfort and support. As shown in FIG. 8, an inner liner fabric 310 of the tongue 300 is preferably one of the other inner materials mentioned above, especially the evolon nonwoven, polypropylene, polyester or lycra blend, polyester microfiber by Coville or the like DriLine or the polyester looped terry or the like. This inner liner fabric 310 is preferably laminated to a structural support foam 320, which is preferably a ¼ inch anti-microbial reticulated and/or slow recovery punctured foam. A hydrophilic open cell or reticulated perforated foam 330 abuts a structural support foam 320. The hydrophilic open cell or the slow recovery perforated foams 330 can take the shape of the foot bones and protect the upper foot from damage. A moldable spacer material may also be used in combination with the foam 330 or in some cases in place of the foam 330. The structural support 320 can also be shaped to accommodate the foot and protect the ankle bones. A moisture transfer material 340 lies over the outer edges of the hydrophilic perforated foam or combination foam and spacer material 330 and is connected to the inner liner 310 and underlies the outer protective polyurethane layer 350. This moisture transfer material 340 is preferably made from a material known as aero-spacer Dri-Lex, which is manufactured by Faytex Corp, or an aero-spacer fabric manufactured by Apex Mills or the like. Optionally, a nonwoven material such as Sontara Technology manufactured by DuPont can be used.

The nonwoven material such as Cambrelle Dri-Lex, Nextec synthetic leathers, Evolon a spun lace moisture management products by Freudenburg can product strength and moisture transfer properties to the tongue. It should be understood that these nonwoven materials can always be substituted for the aero-spacer Dri-lex, even if not specifically mentioned in other parts of this disclosure. This material 340, is wrapped around the outer edge of the tongue to allow moisture vapors traveling from the upper foot area to escape through moisture transfer material 340 to the outer surface of the tongue 300. Material 340 also aids in providing a softer edged tongue. Finally, and outer protective polyurethane layer 350, or the like, is provided over a central portion of the material 340. Another hydrophilic open cell foam or slow recovery punctured foam (not shown) is shaped to fit between the outer protective polyurethane layer, Cordura nylons, Kevlar, or synthetic breathable leathers (by Daowoo Corporation, for example) 350 or the like are surrounded by aero-spacer Dri-lex 340, or a substitute as mentioned above, or the like. The protective polyurethane layer may be optional in both the shell liner and the soft boot. If the protective polyurethane layer is omitted, then the slow recovery foam (not shown) or open cell foam may also be omitted.

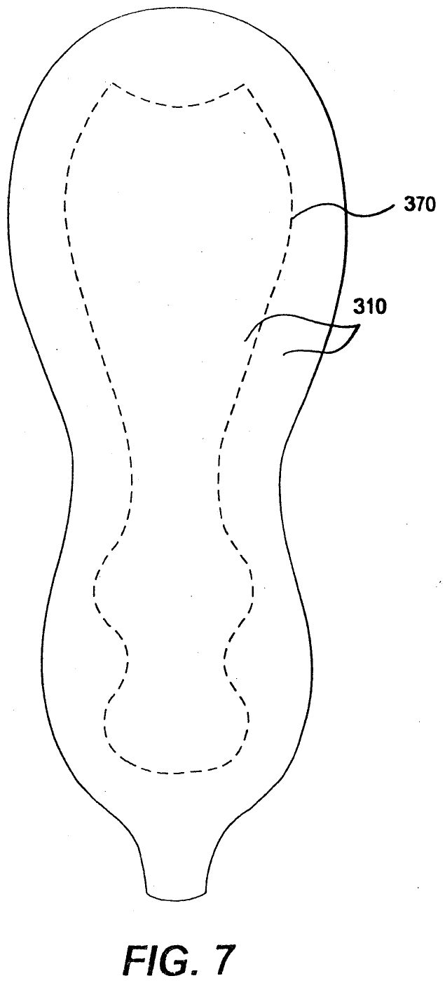

As shown in FIG. 6, polyurethane, Kevlar fabrics, or synthetic breathable leather layer (by Daewoo Corp. for example) 350 is surrounded by aero-spacer Dri-lex 340, or a substitute as mentioned above. At the top of the tongue 300 is an abrasive grip fabric 100 (such as that manufactured by Schoeller and identified by the number 6500), also shown in FIG. 4. Stitching is identified by numeral 370. FIG. 7 illustrates a top portion of the tongue 300, and shows stitching and the inner liner fabric 310. It is recommended that lycra and nylon thread such as those used by the DuPont Xymid Group or Tietex be used for these stitched areas or adhesive bonding by Applied Extrusion Technologies, or the like. In fact, adhesive bonding may be utilized in place of or in combination with several stitched areas on the outer liner fabrics.

In-line and hockey skate tongues have in the past been synthetic hard edged forms. The shape of these tongues often did not fit the skater's foot. Furthermore, vinyl may damage the upper foot where they meet the inner lining edge during active use of the in-line skate. As a result, the skater may develop blisters, calluses, or bruises on this upper-foot area. MVT brushed microfibers, fabrics and nonwovens blends in this liner system increase performance and prevent foot damage. Additionally, the inner fabrics of the tongue liner have often been non-breathable nylon, nonwovens and vinyl, thereby increasing the possibility of foot bacteria and fungus to develop. The optional anti-microbial fiber blends and ionized fibers and fabric discourage bacteria and fungus growth.

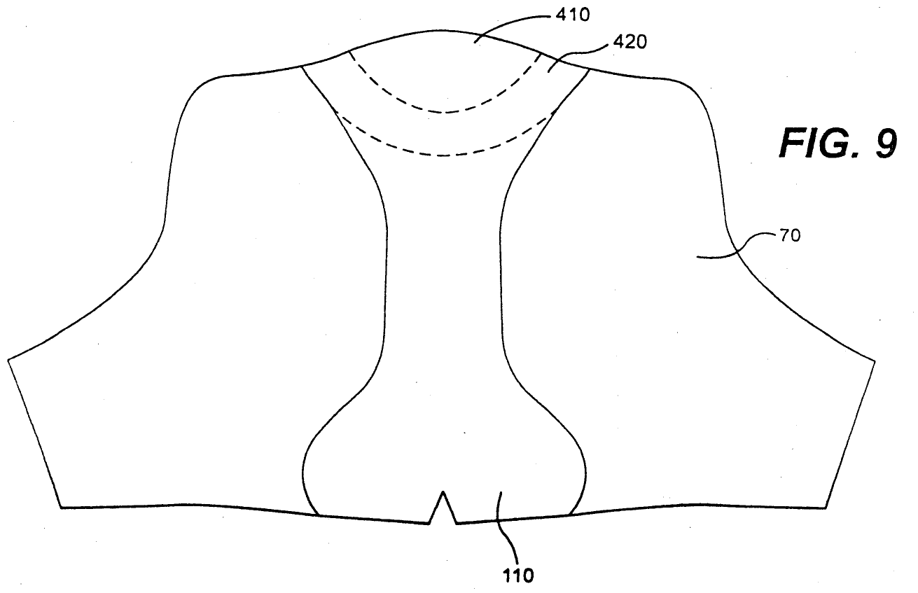

The liners are preferably provided with a pull tab 90 as illustrated in FIGS. 4, 9, and 10 on the back of a cuff 80 constructed of neoprene or reticulated foam covered by lycra, or the like. FIG. 9 shows an opened up version of the liner looking from the back of the shoe. The outer upper cuff, that is exposed above the shell of the in-line skate removable liner, is provided to protect a skater's leg from abrasion. Located just beneath the cuff 80 is an abrasive grip fabric material 410, such as that manufactured by Schoeller, Inc., Nam Liong or the like. Below material 410 is a reflective grip material 420. Below the reflective grip material 420 is a highly abrasive fabric 110, as shown in FIG. 4. The reflective material 14309 by Schoeller or Texon may also be used as fabric 110. Fabric 110 is preferably a Kevlar by Toray, DuPont, or Schoeller (Keprotec or Schoeller Spirit) or Texon, Starlite, Cordura, or the like. Finally, outer shell fabric 70 is the same as that shown in FIG. 4, and can be any of the fabrics listed previously in connection with outer shell fabric 70. The nylon pull tab 90 allows the skater to easily slip into the liner.

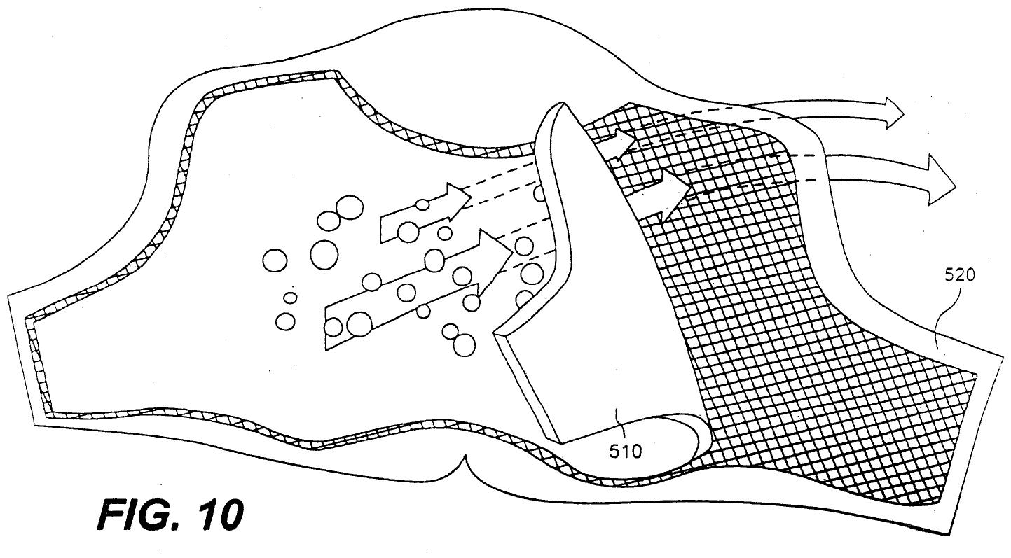

FIG. 10 shows the other side of the liner of FIG. 9. In FIG. 10, 510 can be a ¼ inch punctured moldable foam, spacer fabric, or an air bladder of a similar shape. The foam and air bladder may also be used in combination. Alternatively, the moldable foam or cellulose material can be substituted by a reticulated or hydrophilic open cell foam, silicon gel or Dicon foam or the like. A nonwoven top sheet (with or without apertures) can be attached to the moldable foam or be selected fibers may be included in the foam during formation. Also, a spacer material, such as that made by Muller or the like, or a cellulose material by FoxRun can be used as material 510. 520 represents the combination of the flexible mesh (in the case the moldable foam is not used, as depicted), the breathable membrane and the outer shell fabric or encapsulated outer shell fabric. As in all of the figures, the arrows depict the flow of moisture.

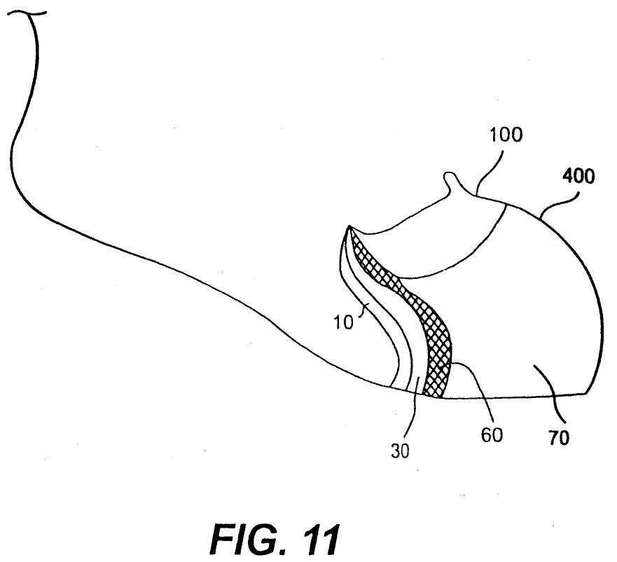

FIG. 11 illustrates the toe portion 400 of the shoe. Preferably, the toe portion 400 is constructed with an inner liner 10, followed by a foam material 30 or foam and mesh with or without fibers, followed by a breathable membrane 60 and the outer fabric 70 or encapsulated outer shell fabrics. The optionally a foam and nonwoven fiber blend nay be used abutting the mesh or spacer material in the top box and heel.

Abrasive grip fabric 100 is also shown. Texon Aquiline or a Nam liong nylon or kelvar product may be used.

The 6500 high abrasive fabrics manufactured by Schoeller, inc., Nam Liong kelvar and nylon fabrics or the like, are located on the back of the cuff and the top of the toe box, heel, and tongue grip area. The Kevlar and Cordura Starlite fabrics provide comfort and durability to the liners and are extremely strong and resistant to abrasion and allow for breathability and performance.

The microfiber technology disclosed above is rapidly developing and changing and has greatly increased the potential for improved performance of such products as in-line skates, provided that they are properly utilized as in the present invention. These new products are part of rapidly developing fabric technology. The present invention employs a combination of fabrics, foam layers, nonwovens, spacer fabrics, breathable membranes, polymer mesh and cellulose materials, flocked fibers and foams technology, encapsulated technology, structural woven water repellent fabrics, or waterproof film coatings in such combinations that increase the performance of the products in which they are used as well as increase breathability. The waterproof/breathable membranes in this application may have anti-microbial fibers and/or nonwoven fibers flocked to them to increase performance properties.

It should be noted that, in the case of in-line skates, the lining system of the present invention can be applied to both shell boots and soft boots. The soft boot in-line skate mentioned earlier in the background of the invention addressed the needs of a skater to have more flexibility and comfort yet still maintain performance levels. This new technology in the hockey, ice and in-line skate industry has increased tremendously the possibilities of a lighter weight performance product. The soft boot in-line skate has numerous combination of the moisture transfer composites prior. The liner of the soft boot can be adapted to this new moisture transfer system. While the soft boot does not have a protective shell, nor a removable liner it can nonetheless be provided with a liner that enjoys all of the benefits of the liner according to the present invention. Preferably, the outer layer of the moisture transfer system for the soft boot application would be a Starlite Dri-lex nylon, Kevlar, or high abrasion Cordura fabric, such as that manufactured by Schoeller, Nam Liong or the like. These fabrics, as well as the high abrasive fabrics, are encapsulated or are provided with a waterproof/breathable membrane or coatings. A reticulated and/or open cell hydrophilic anti-microbial germicidal ⅛ inch foam or the anti-microbial nonwoven and foam blend manufactured by Foss Manufactured abuts the encapsulated outer fabric or breathable membrane. The structural mesh, combined mesh and foam composite, molded cellulose or spacer material is stitch bonded or laminated to the ⅛ reticulated or open cell hydrophilic foam. A slow recovery punctured foam, cellulose material, spacer material or silicon gel, or the like, are located in the heel pocket, tongue, and toe areas. An air bladder may also be added around the ankle areas to increase performance in some cases. The structural mesh or molded spacer materials abut a nonwoven top sheet or a foam and nonwoven composite that is laminated, stitched, or ultrasonically bonded to a reticulated and/or open cell hydrophilic ⅛″ inch foam. The ⅛″ foam abuts preferably a cellular elastomeric composite which is laminated to the inner fabric. A nonwoven top sheet laminated to ⅛″ foam may also be used in place of the elastomeric composite. Also, instead of being removable, the liner would preferably be directly attached to the base of the soft boot by methods well known in the art, such as that disclosed in U.S. Pat. No. 5,437,466. Substitutions can be made to all of the foam materials (i.e. hydrophilic open cell, Aquazone, Premium, VPF etc.) just as discussed earlier, and are not specifically repeated here. Other aspects of the present invention can be applied to the soft boot without any significant structural changes. The soft boot density is increased in the footbed, toe box, and heel plate. This added support provides protection and assists in maintaining technical performance levels. The in-line soft boot breathability would be greatly enhanced with this added moisture transfer liner system. The soft boot may also employ the nonwoven top sheets and composites in a number of combinations with the foam layers to increase moisture transfer.

Also, the soft boot outer shell may be a combination of synthetic breathable leather (such as that available from Daewoo, Inc. Nextec or the like), an encapsulated, waterproof film or breathable membrane outer fabric by DuPont, Schoeller, Burlington, Malden Performance Fabrics or any of the former fabrics mentioned, or the like, as well as synthetic rubbers, PVC, TAR or CPU, a thermoplastic composite material. Typar Nonwovens by Sontara Technologies, Texon, or the like, may be used in combination with the outer materials in high abrasion areas.

The outer shell combined materials are then laminated, stitched or ultrasonically bonded, or the like, to interior foam or foam and nonwoven layers. An air bladder may be added in combination with or in place of the molded foam and structural mesh to aid in comfort and performance. If the internal layers of foam and nonwovens are stitch bonded, it is recommended that the process with lycra thread by the Xymid group of DuPont be used or the process developed by Tietex with nylon thread, or the like. The outer shell fabric seams may be stitched or adhesively bonded. Alternatively, the outer shell is a moldable composite of shell fabric foam, needle punch thermal nonwoven with or without foam abutting inner lining material. The exterior shell material is bonded to the nonwoven by foam and may optionally include a mesh and/or fibers with anti-microbial properties. The inner lining material may be stitched, laminated or bonded with adhesives, breathable membranes or lamination to the exterior shell composite. The exterior shell fabric material may or may not be waterproofed.

The inner moisture transfer fabrics are any of the former fabrics listed as suggested for the removable liner, or the like. The foam is manufactured by Olympic Vita, Dicon, Foamex or the like, in combination with a nonwoven topsheet as mentioned or the foam-nonwoven combination may be replaced with a foam/top sheet composite referred to as a cellular elastomeric composite. Presently, this invention is considering the use of a breathable polyester, shaped polyester (4 deep grove or the like and/or polypropylene filtering material produced by Vitafibers QW 110-QW 150 quiet web or Tangerding Vliesstoffe (TH-FI 210B or FF-FI 250). These materials may be substituted for the reticulated or open cell foams previously mentioned, materials 30 and 50 for example. The composite combination an be used for apparel, medical, industrial and protective application. Tangerding Vliesstoffe or the like may have an anti-microbial fiber added with the phase change material to increase the performance properties. This combination may be used industrial for air or water filtering applications. In fact, a large number of the skate composites and combinations of compositions in this invention may be used in medical and industrial applications.

Alternatively, the elastomeric cellular composite or the cellulose spacer material by FoxRun may have anti-microbial and/or nonwoven flocked to one side or both sides. The elastomeric flocked composite combinations may be use in numerous combinations for skate, soft boot and alpine shell boots and insert liners, apparel, medical and industrial applications.

In fact, a large numerous of the above composite combinations may be used for protective gear, sporting goods apparel, backpacks, tents, sleeping bags, bouldering shoes, sailing and golf apparel and footwear, as well as, apparel and footwear. In the padding and sailing apparel and accessories the kapok fiber may be added to increase buoyancy.

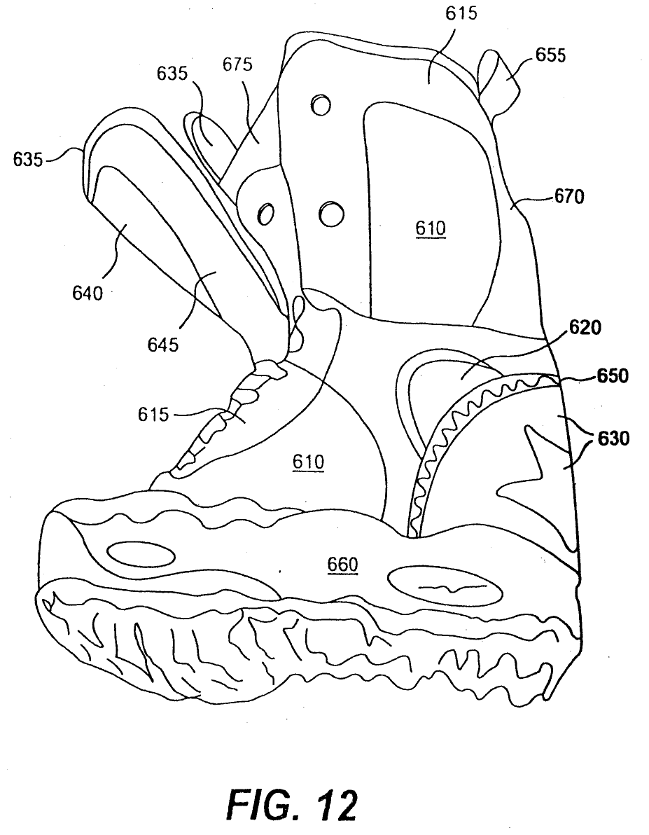

FIG. 12 illustrates a snowboard or alpine insert boot liner incorporating the lining system discussed above. The snowboard boot may have a removable or non-removable liner as discussed above for the alpine boot. The following elements of the snowboard boot are shown: numeral 610 represents a waterproof breathable synthetic leather or a leather by OutDry (Nextec), a KEVLAR fabric (made by Schoeller, or a similar material), Schoeller, DuPont & Toray or the like, Cordura, DYNAMIC EXTREME, KEPROTEC, or DERMIZAX by Toray; numeral 615 represents materials similar to that of numeral 610, but can have different colors for aesthetic purposes; numeral 630 represents a KEVLAR or a material made by Schoeller, NAM LIONG, a synthetic material, leather or the like, with the heel portion being synthetic rubber, EVA, or the like, manufactured by Daewoo; numeral 635 represents an inner moisture transfer material covering a breathable molded breathable foam or breathable a spacer product numeral 640 represents a KEVLAR or Cordura material; numeral 650 represents some decorative piping made of synthetic leather, stitching, polymer or the like; numeral 655 represents a pull tab made of nylon or synthetic leather; numeral 660 represents the base of the boot which can be made of a synthetic polyurethane; numeral 670 represents a reflective KEVLAR back; and finally, numeral 675 represents an optional sock that can be inserted into the boot with the permanent liner or removable insert liner if desired.

The sock 675 is made up of three or four layers and similar to the thin race boot option. The first layer can be any of the inner liner materials discussed above. The second layer is a layer of elastomeric composite, foam composite or nonwoven composite, thermal nonwoven composite, Themolite, Thinsulite, Gore nonwoven with or without foam or silver fibers. The third layer is a material that absorbs and transfers moisture such as a ionized nonwoven blend, polyester blend manufactured by Deercreek fabrics, Menra Mills, NAM LIONG fabric treated with a wicking solution or the like. This layer is optional. The preferable outer shell insert sock construction may be a three layer composite constructed of an inner lining material, a nonwoven composite with foam or without foam and silver fibers and an outer shell polyester mesh waterproof with a encapsulated, film or a finish. The inner lining fabric and outer shell layer material may be a nonwoven, knitted mesh or a woven construction.

Encapsulation technology can also be applied to the third layer by Nectex. Sock 675 can be used for additional warmth and is removable, unlike the shoe liner and can be insert into the snowboard, alpine liner or the like, for extra warmth. The insert sock liner is breathable and preferable used in a boot where the liner is not removable or there is no liner available. The three layers can be attached to one another by lamination, although mechanical bonding, or stitching, or ultrasonically bonded, can also be used. This insert sock liner is recommended for the all-weather boot by L.L. Bean or the like.

The alpine and snowboard race boot requires a thin moldable liner option. The insert liner for the alpine race boot preferably is constructed in following three options; Inner lining material abutting an open cell foam backed with a moisture transfer nonwoven top sheet. The three layer composite is laminated to the Foss thermal composite and a spacer fabric material The exterior shell fabric is laminated to the a spacer fabric material.

In the second option the inner lining material is laminated to the Foss thermal composite and abuts the breathable moldable spacer fabric and exterior shell material.

In the third option the inner lining material is welded to elastomeric composite, the moldable breathable spacer fabric and exterior shell material.

Optionally, the exterior shell fabric may be a three layer composite constructed of foam, moisture transfer nonwoven and the exterior shell fabric. The three layer exterior composite may be attacked to the breathable spacer fabric and molded. In fact, any of the combinations may be molded and welded in this inventions.

The microfiber and chemical ionized technology disclosed above is rapidly developing and changing and has greatly increased the potential for improved performance of such products alpine boot, provided that they are properly utilized as in the present invention. These new technical fibers, materials, foams and moisture transfer composite combinations are part of rapidly developing technical textiles technology industry. The present invention employs a combination of fabric, foam, moisture transfer nonwovens, moldable spacer materials, breathable membranes, coating, finishes, films, structurally woven or knitted waterproof fabrics, ionized fabrics, encapsulated outer fabrics in such combinations that increase the performance of the products in which they are used as well as increase breathability. The breathable membranes, coating and finishes are optional in alpine, hiking and climbing shoes. The removable sock liner may be insert into rubber boots and all weather boots or alpine products. The discussion above has focused upon snowboard boots, alpine boots, hiking and climbing shoe liners similar applications can be made with running shoes, helmets, protective gear or cross country boots, or in-line skates, gloves, accessories, sleeping bags, back packs and apparel with slight modifications.

The snowboard boot liner, the various layers can be combined by lamination, mechanical bonding, stitch bonding, ultrasonic bonding or a combination of these two. The second and third layers would include a foam that contacts the first layer and is a germicidal, reticulated foam or a hydrophilic, open-cell foam, such as DuPont and VPF manufactured by Foamex, DRI-Z manufactured by Dicon with or without glycerin, COMFORTEMP by Frisby and Schoeller or the like. Alternatively, these layers can be a Foss thermal composite. An elastomeric cellular composite inclusive of moisture transfer nonwoven fibers or a open cell foam backed by a moisture transfer nonwoven apertured top sheet composed of wood pulp, polyester, rayon, lyocel, cotton, or polypropylene, in a single process. A foam composite may be used in combination with a thermal nonwoven.

The fourth layer is a hydrophilic, open cell preferably, (DuPont or VPF), a slow recovery foam, or Dicon Technologies foam, or polymer flex-guard mesh or a polymer flex-guard mesh inclusive in a open cell foam or a polyester breathable spacer material (by Muller) or the like for support. In this case, the open cell foam, DuPont is laminated to a moisture transfer nonwoven top sheet composed of wood pulp, cotton, polyester, lyocel, blend which abuts a waterproof/breathable membrane (fifth layer) if used. If the flex-guard polymer mesh is used it is include in the foam in one process or the flex guard is followed by another layer of open cell (DuPont) with a moisture transfer nonwoven top sheet inclusive in the foam or abutting the waterproof/breathable membrane or an encapsulated or waterproof breathable coated or filmed exterior shell fabric. If the spacer material is used to may or may not be molded to accommodate the foot. The moisture transfer nonwoven top sheet may be eliminated in selected performance categories. The breathable spacer material abuts either a waterproof breathable membrane, an encapsulated or coated fabric. The breathable spacer material may combined with a THERMOLITE or the Foss thermal composite.

The Phase Change Technology by OUTLAST, Frisby may be added to any layer in the liner system and may be combined with encapsulated fibers and fabrics. Phase Change Technology can be used in conjunction with structurally knitted waterproof fabrics or fibers, or with the encapsulation fabrics by Nextec, Toray or the like. Encapsulation by Nextec combined with the OUTLAST Technologies is an enhance option in this embodiment, but is not essential in the products. If encapsulation is employed, then the fourth layer preferably includes THERMOLITE or the Foss thermal composite. If a non-removable liner is employed instead of a removable liner, a waterproof-breathable thin film, finishes or coating can be used instead of encapsulation or a waterproof/breathable membrane.

The sixth layer in this removable shell liner may be Cordura, STARLITE, KEVLAR fabrics or the like. The STARLITE by Faytex Corp or Faytex breathable series, Kevlar and Cordura's by Schoeller 6500, 14705, 13207, 13632, 65563 etc. and NAM LIONG's ARMORTEX Series, DERIZAX and ENTRANT Gil by Toray.

The exterior shell fabric is and preferably encapsulated or waterproofed with a breathable thin film or coating.

### Alpine Cross Country Boots

A liner for the alpine cross country boots has a first layer selected from a group including polypropylene, nylon blend, polyester or polyester blends, LYCRA or wool backed by cotton, wool, rayon, lyocel, acetate, acrylic, polyester or a nonwoven blend. The inner ling fabric or material may be an anti-microbial, anti-fungal INNOVA or ALPHA; sueded polyesters; polyester field sensor; looped polyester terry; Dri-line by Milliken, DRI-LEX DOESKIN or BABY KID or the like by Faytex Corp.; polyester DRI-LEX terry by Faytex; polyester fleeced blends or spacer fabric by Malden; and polypropylene backed by cotton by Coville.

Alternatively the three layer composite by Faytex, Dicon or the like may abut the second layer.

The second layer in this embodiment may be a open cell foam, or a moisture transfer nonwoven composite, or a breathable moldable spacer fabric or the outer shell material. These material may be individually selected or in combinations in certain performance categories.

The second layer is a germicidal, open cell hydrophilic foam. It may be COMFORTEMP by Frisby or DuPont with Phase Change Technologies or a foam by Dicon Technologies with or without glycerin. This foam can be provided with or without a moisture transfer nonwoven top sheet. The moisture transfer nonwoven top sheet can be selected from any of the materials previously specified. Alternatively, the second layer may be an elastomeric composite or the second layer can be a open cell foam such as DRI-Z or DuPont or the like with a fiber integrated into the foam during it's construction. This composite of fiber and foam is created in one process and may in some performance categories contain a polymer mesh such as that developed by Naltex or a webbing. The open cell foam with or without the polymer mesh may alternatively, contain a fibers nonwoven sheet constructed of the above suggested fibers contained in the nonwoven backing. The assist in the absorption and transfer of the moisture passing through the moisture transfer system.

The third layer is a structural support foam or a breathable moldable spacer material by Muller Textil. The heel and arch may also have a slow recovery foam or spacer fabric added for comfort. The thickness of the layer of foam or spacer fabric and THERMOLITE may vary for performance.

The fourth layer is a thin layer of THERMOLITE, a hollow core polyester fibers, THERMOLITE combined with a with a open cell foam with or with out nature fibers such as corn fibers added. Optionally, the third layer can be a blend of moisture transfer synthetic or nature fibers blend or the THERMALFOSS nonwoven composite with or with out DuPont thermal fibers or an open cell foam such as DuPont or the like with a moisture transfer nonwoven top sheet made of wood pulp, lyocel, rayon, cotton, polyester, acrylic, acetate, corn or polypropylene. These nonwoven fibers in combinations or independently absorb and move moisture. The fourth layer may be optional in some performance categories.

The fifth layer is optionally, a breathable waterproof/breathable membrane which may be any one of the following: SECO at Shawmut Mills, THINTECH, THERMOLITE 2000/1300 standard, laytex, breathable membranes by Harrison Technologies, Sympatex, or ENTRANT Gil by Toray The OUTLAST Membrane can be used by itself, with another membrane or with encapsulation technology on the outer shell fabric, such as Nextec, Toray or the like Alternatively, instead of the membrane, encapsulation technology or a waterproof breathable finish or film may be applied to the exterior shell materials of the sixth layer and can achieve similar results. Optionally, a combination of Phase Change Technology and encapsulation fibers or fabrics by Nextec or Toray. If encapsulation is employed, then the fourth layer preferably includes THERMOLITE, a moisture transfer nonwoven blend or THERMALFOSS composite.

The sixth layer is one of the following fabrics. Note that if these fabrics are encapsulated, the waterproof/breathable membrane in the fifth layer may not be needed in combination. These fabrics include the following: Cordura; LYCRA blends; STARLITE by Faytex Corp.; KEVLAR fabric by Schoeller (14705, 6500, 13207, 13632, 65563, etc.); NAM LIONG, AROMRTEX Series, DuPont and Toray or the like, Cordura 2000 by DuPont, Dermizax and ENTRANT Gil by Toray, 3 or 4 ply Supplex; Mojave and Tudor nylon and polyester blends by Travis; 6 ply Maxus nylon blends or the like; and synthetic leathers by Daewoo, Inc., Nextec or moisture transfer nonwovens by Freudenberg, Sisa or the like. These fabrics may be used individually or in combination.

The seventh layer is a LYCRA covered neoprene, moldable spacer fabric or slow recovery foam or reticulated open cell foam ankle cuff.

The tongue for the alpine boot is similar to the tongue of the in-line skate. The tongue of the cross country boot is similar to the snowboard boot. They can be constructed of DuPont molded foams with a moisture transfer nonwoven top sheet or moldable spacer fabrics. A slow recovery foam can also be used as specified with the snowboard boot. The inner fabric is one or more of DRI-LEX, DRI-LEX Aero-spacer, polyester FIELDSENSOR polyester by Toray, Freudenberg nonwovens, DRILINE by Milliken, polyester spacer by Malden, polar fleece INNOVA or ALPHA polypropylene by Coville or Deercreek fabrics, or DRI-LEX DOESKIN nylon, polyester blends sueded or fleeced or the like. The outer tongue fabrics are high abrasive fabrics constructed of KEVLAR and Corduras by Schoellar's or NAM LIONG and DRI-LEX Aero-Spacer (or other Aero-spacer materials by Faytex, or the like, and breathable synthetic and natural leathers by Daewoo, Nextec, or the like. All the leather in this embodiment can be treated with OutDry by Nextec.

### Hiking Boots

A liner for the hiking boot would include the following. The first layer is selected from a group including: polyester field sensor; looped poly terry; DRI-LEX composites by Faytex; Doeskin, baby kid, Cambrelle by Faytex; anti-fungal, anti-microbial polypropylene fabrics; INNOVA or ALPHA fleeced polyester and polypropylene blends, sueded polyester blends, COOL MAX or nylon blends, or the like. Any combination of these moisture transfer fabrics can also be used.

The second layer is a cellular elastomeric composite or hydrophilic open cell foam preferably DuPont, COMFORTEMP by Frisby/Schoeller or DRI-Z by Dicon. The OUTLAST membrane is an option in this layer. If a foam is used, a moisture transfer nonwoven top sheet selected from previously mentioned materials can be attached as a backing.

The third layer is a molded hydrophilic open cell foam preferably DuPont backed by an aperture top sheet composed of cotton, polyester, polypropylene, Lyocel, rayon, or wood pulp, cotton or the like. A moldable heel and ankle spacer fabric by Muller or the like may also be used in place of the third layer of hydrophilic foam. A breathable moldable spacer fabric or foam may be added around the toe box and back cuff. A molded heel/ankle insert by Muller Textil is preferably also used.

The fourth layer optionally is a waterproof/breathable membrane which may be any one of the following: OUTLAST membrane by Gateway Technologies combined with Seco-Tex, TX1540 (distributed by Shawmut Mills), THINTECH, THERMOLITE 2000/1300 standard, Laytex, WILCOFLEX DRY or the like. The OUTLAST Technology may also be used independently of the breathable membrane and may also be coated to the outer fabric or fibers. Also, this membrane layer may be eliminated in some models depending upon the hiker's needs. Alternatively, instead of the breathable membrane, encapsulation of the fifth layer can be performed to achieve similar results. If encapsulation is employed, then the third layer may be an open cell foam or a moldable spacer fabric, a THERMOLITE, a moisture transfer nonwoven composite or a THERMALFOSS composite. The Phase Change Technology may be applied to the moisture transfer nonwoven, foam or fabric in this moisture liner system and may be combination with outer shell encapsulated fibers and fabric, such as by Nextec, or the like.

The fifth and last layer is a combination of one or more of the following: Corduras, Supplex Nylon, STARLITE, Tudor, KEVLAR, nylon blends, polyester nylon blends, and waterproof breathable synthetic and natural leathers. Preferably, this layer is waterproofed by using encapsulation, waterproof finishes or films or coatings. Waterproof treatment to the exterior shell leathers, synthetic leathers and/or materials can be applied by OUTDRY by Nextec, DURAPEL PLUS, HYPER D-WR or ENTRANT G2-XT.

Elastomeric composite technology may be insert between the exterior shell fabric and the breathable membrane if applied or the elastomeric composite may about a moisture transfer nonwoven thermal blend one side and the exterior shell fabric on the other side. Optionally, the thermal nonwoven composite may be abutting the exterior shell material. Furthermore, the breathable liner according to the present invention could also be added to clothing such as shirts, pants, gloves, helmets, backpacks etc., by omitting elements such as the structural mesh and by adjusting the number of foam material layers and their thickness. For example, clothing preferably has a wickable inner liner, followed by an elastomeric or an open cell foam 1/16, ⅛ and the outer shell fabric. A moisture transfer nonwoven may or may not be laminated to the foam. Optionally, a breathable membrane abuts the foam or moisture transfer nonwoven and is laminated to the outer fabric. The outer fabric may be waterproofed by encapsulated, laminated to a breathable waterproof membrane, coated with a waterproof finish or film, or structurally woven or knitted to repel water. If encapsulation technology or a waterproof breathable film or finish is applied to the exterior shell fabric than the breathable membrane may not be applied. Indeed, the amount of foam may be replaced by a nonwoven composite blend. Presently, this liner system is combining a open cell foam abutting a open cell foam and encapsulated outer shell fabric as one embodiment Optionally, the FossThermal, THERMOLITE or a nonwoven thermal or nonwoven composite combined with foam may be used abutting the inner ling fabric and the outer shell fabrics.

This invention can also be used for industrial and medical applications by using polyester spun bonded filter products by Tangerding Vlitesstoffe, Vitafiber, or the like, combined with alternating hydrophilic foam layers and nonwoven blends. The nonwoven composites are constructed to filter, absorb and transfer moisture and microscopic particles.

### Other Applications

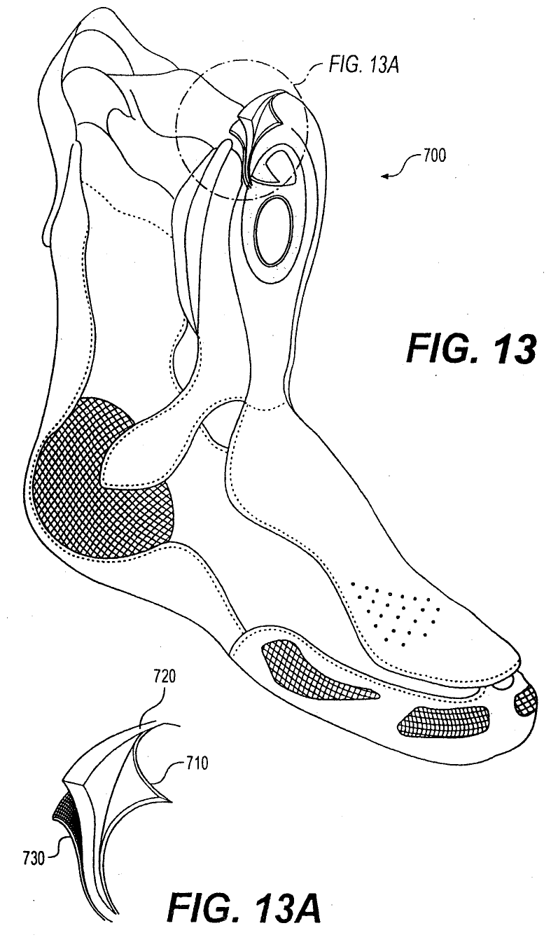

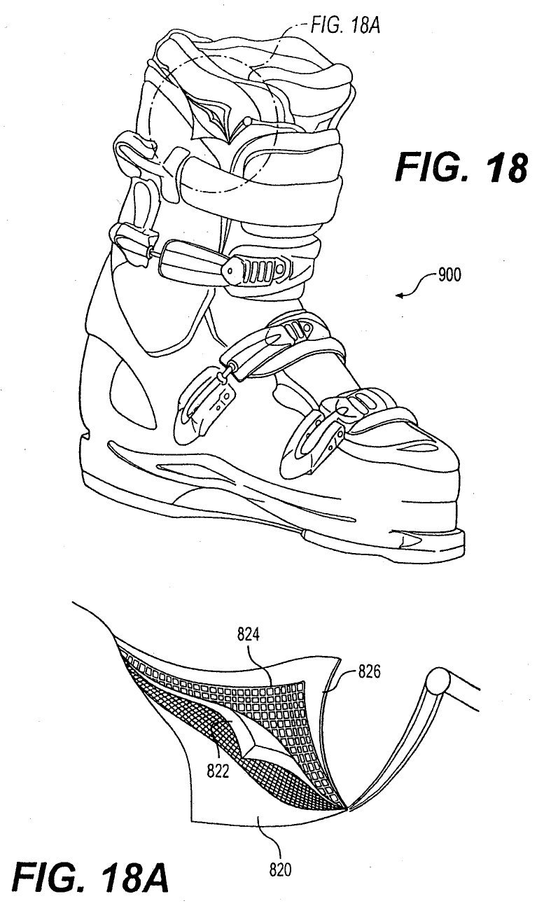

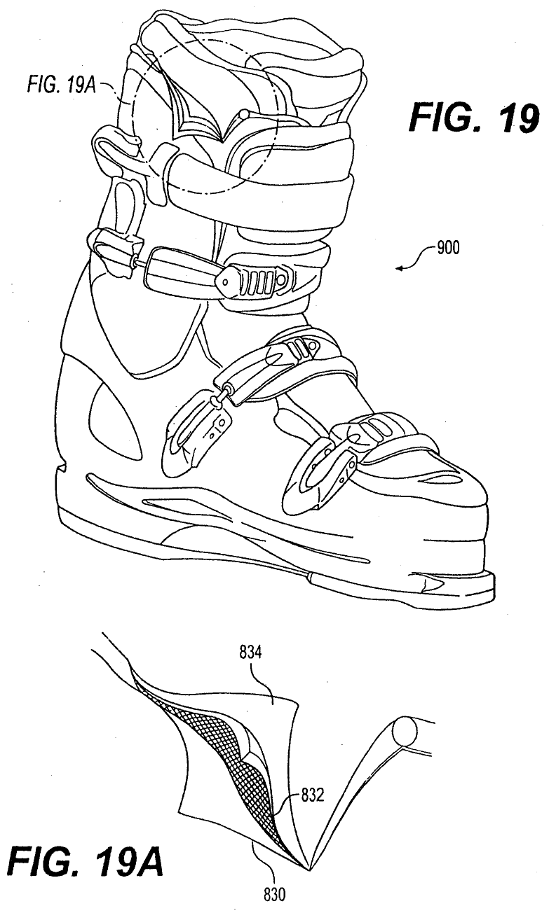

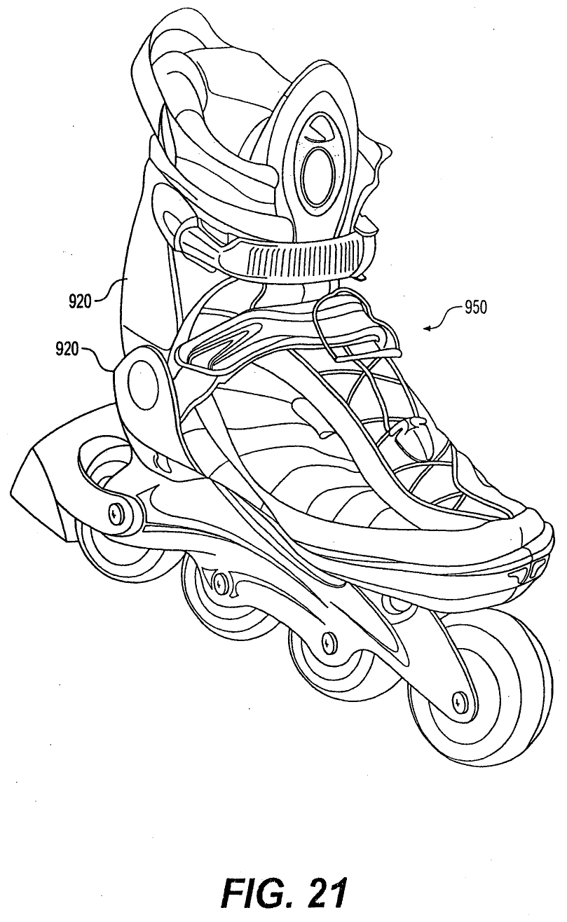

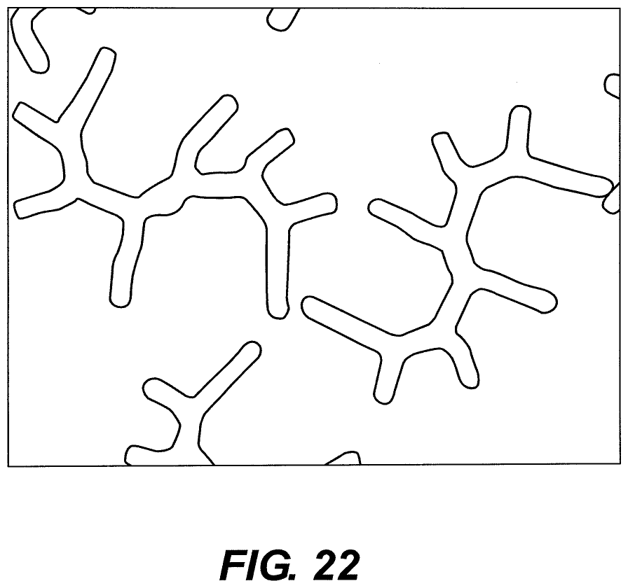

FIGS. 13-22 disclose various other embodiments of the present invention as follows. FIGS. 13-18 show a detachable, removable insert liner for soft shell skates and other products. These liners are inserts and can be used in hockey skates and other types of footwear. The same construction can be applied to a complete boot rather than an insert. This is shown in FIG. 21. FIG. 21 is an example of a complete skate containing the same materials as the inserts in FIGS. 13-18, and built in the same way as these inserts. Soft shell alpine boots are illustrated in FIGS. 18 and 19.

FIGS. 13 and 13A illustrate an insert (700) for an in-line skate or hockey skate with a first portion enlarged. In FIG. 13, numeral 710 represents a composite of one layer, two layers, or three layers. 710 shows outer shell fabric, foam, nonwoven, with no top sheet—the top sheet is the outer shell fabric in this case. 710 can be an exterior shell fabric or material abutting a cellular elastomeric composite, or the fabric can be backed by a flocked fiber combination abutting the foam and followed by a nonwoven or a knit. Alternatively, the same combination may be used without flocking. Optionally, layer 710 can be a single layer of fabric or material, or a double layer, including fabric or material abutting a nonwoven. Preferably, the composite layer is a 3 layer construction of fabric, foam, and nonwoven. Layer 720 is a spacer fabric. Optionally, layer 720 is a combination which may include multiple layers of foam and nonwoven. In some performance categories, 720 can be simply a foam or a nonwoven. Layer 730 is a nonwoven, or a cellular elastomeric composite or an inner lining fabric or material such as a knit.

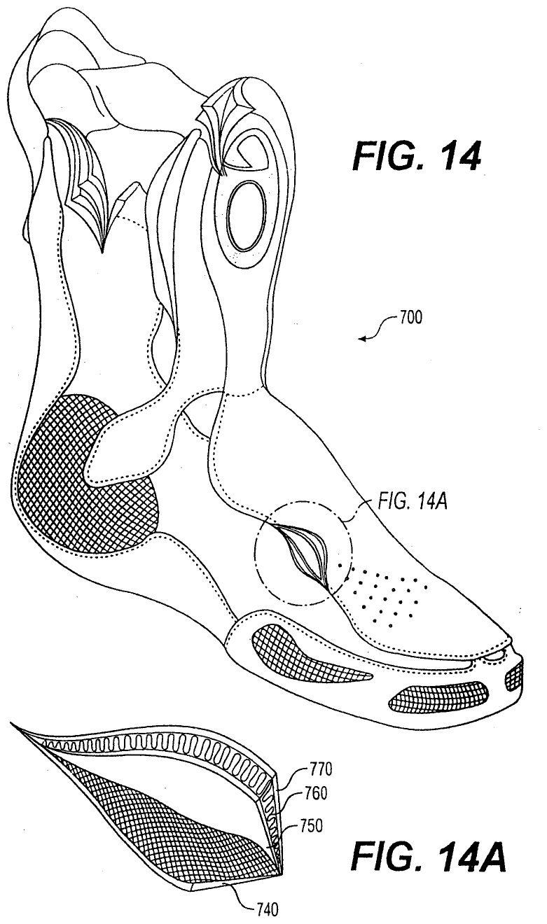

FIGS. 14 and 14A illustrate another embodiment of an insert (700) for an in-line skate or a hockey skate with a second portion enlarged. 740 illustrates a one, two, or three layer composite. The top sheet can be optionally composed of: 1) a nonwoven or a knitted layer; 2) a nonwoven or a knit and a foam; 3) a nonwoven or a knit with a cellular elastomeric composite; 4) a nonwoven and a foam composite.

Layer 750, 760 and 770 together compose a spacer fabric or a moldable foam with a mesh. Optionally the spacer fabric or foam with a moldable mesh may include a nonwoven thermal such as Thinsulite or Thermolite with or with out silver fibers by Foss Manufacturing or the like or a thermal composite made of nonwoven fiber blends and silver fibers. The preferable construction replaces the 3 layers (750, 760, and 770) with a single layered spacer fabric. In some multilayer constructions, the specific layers could be broken down as follows: 1) layer 750 may be a knit, woven, nonwoven construction, or foam, or an elastomeric composite; 2) layer 760 may be a foam, nonwoven or a combination of foam and nonwoven; 3) layer 770 may be a knit, woven, nonwoven, foam, or an elastomeric composite.

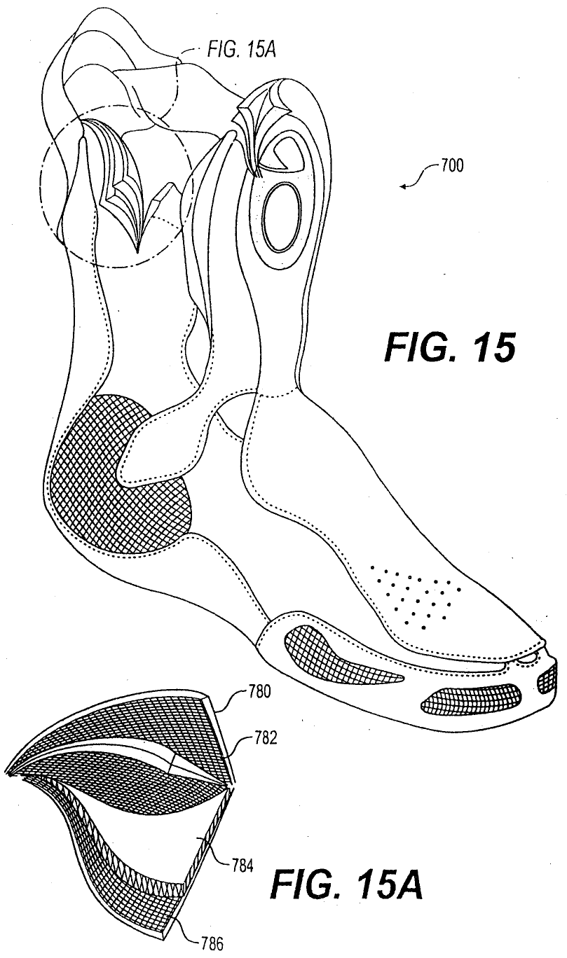

FIGS. 15 and 15A illustrate another embodiment of an insert (700) for an in-line skate or hockey skate with a third portion enlarged. 780 could be a combination of an outer fabric and a foam or a combination of an outer fabric a foam and a non-woven. 782 has many options. One combination is a foam with a mesh, a non-woven, another foam, and another non-woven. A second combination has a foam, a mesh, a non-woven, a second foam, and a second non-woven. A third combination is a non-woven, a foam, a second non-woven and a non-woven composite manufactured by Foss. Optionally, all nonwoven layers may be a cellular elastomeric composite, and may include silver fibers by Foss Manufacturing.

784 has three options. One option is a spacer fabric. A second option is a moldable foam. The third option is a combination of a foam and a polymer mesh, manufactured by Naltex.

786 has the following options. It could be an outer fabric plus a foam or a foam and non-woven composite (Foss composite). Another option is an outer fabric and an elastomeric composite. Finally, 786 could be a Foss composite and an elastomeric composite together with an outer shell fabric. In some performance products the layers of 782 are omitted. It should be noted here that all composite materials can be backed by a flocked fiber blend which may contain silver fibers.

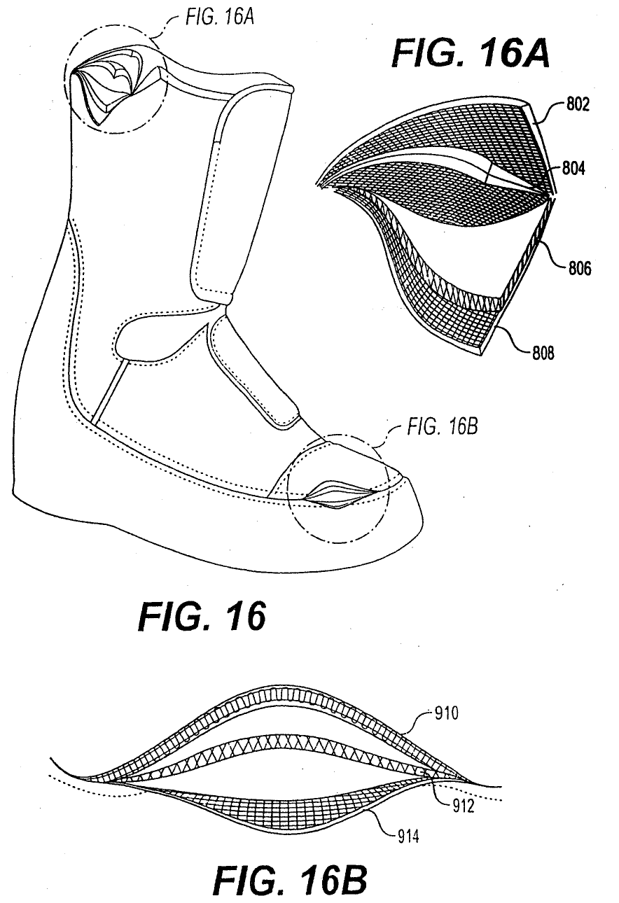

FIGS. 16, 16A and 16B illustrate an insert (800) for a soft-shell alpine boot with first and second portions enlarged. 802 illustrates a composite including an inner moisture transfer material, a foam and a nonwoven. 802 may also be an inner moisture transfer material, abutting a nonwoven and foam composite or a cellular elastomeric composite. 804 illustrates a composite of a nonwoven a foam, a second nonwoven and a second foam. Alternatively, 804 may be composed of a foam and a nonwoven with silver fibers (this combination is an example of a moisture transfer thermal), and in some performance categories a cellular elastomeric composite may be combined with a moisture transfer thermal. This whole layer can be eliminated in some performance categories. Nonwovens in this composite may be replaced by a knitted fabric. 806 illustrates a spacer fabric or a breathable moldable foam. The moldable foam may include a polymer mesh, with or without silver fiber blends, or other fiber blends including wool fibers. In one option the silvers and natural blends abut the spacer fabrics and may be followed by a thermal nonwoven layer. Thermal nonwovens such as Thinsulite and Thermolite he like may include the silver fibers by Foss manufacturing. Layer 806 is a moisture transfer thermal composite composed of a nonwoven, and foam blend. The foam with mesh can be followed by a nonwoven or another foam. The foam nonwoven composite may be constructed in the following ways: 1) foam-nonwoven-foam; 2) nonwoven-foam-nonwoven; 3) nonwoven-foam-nonwoven-foam-spacer fabric; 4) nonwoven-foam-nonwoven-spacer fabric. All of these combinations may include silver fibers or fiber blends and are considered moisture transfer thermals. In some options, the nonwoven layer may be replaced with a knitted layer, or a cellular elastomeric composite. 808 illustrates a cellular elastomeric composite or a foam and nonwoven abutting an exterior shell fabric. The moisture transfer thermal composite may be combined with a polymer mesh and the exterior shell fabric in layer 808.

Alternatively 808 can be the exterior shell fabric open cell foam with or without silver fibers or fiber blends abutting a nonwoven, a nonwoven thermal blend or a nonwoven and foam composite. This exterior shell composite is moldable, transfers moisture, and regulates temperature with fiber additions. The exterior shell fabric may be waterproofed in the following ways: 1) with encapsulation; 2) with breathable membrane; 3) with waterproof breathable film or finish; 4) with fibers treated or constructed to repel water. A preferable three-layer construction for golf shoes, running shoes, cross-country boots and apparel includes a waterproof exterior shell fabric, an open cell foam, or a cellular elastomeric composite abutting a knitted or nonwoven inner moisture transfer material. Optionally the foam, nonwoven or cellular elastomeric composite may include blends containing either silver or wool fibers, or both.

FIG. 16C also illustrates in layer 910 a spacer fabric abutting layer 912. Optionally, 910 can be a foam with a fiber blend and polymer mesh added. 912 is preferably a moisture transfer thermal, composed of a foam nonwoven antimicrobial blend with silver fibers. Alternatively, 912 can be a nonwoven thermal without foam or a thermal nonwoven with silver fibers. 914 is a one-, two-, or three-layer composite. It can be an outer shell fabric or material, abutting a breathable foam followed by a nonwoven. Alternatively, the outer shell fabric may abut a cellular elastomeric composite or thermal nonwoven.

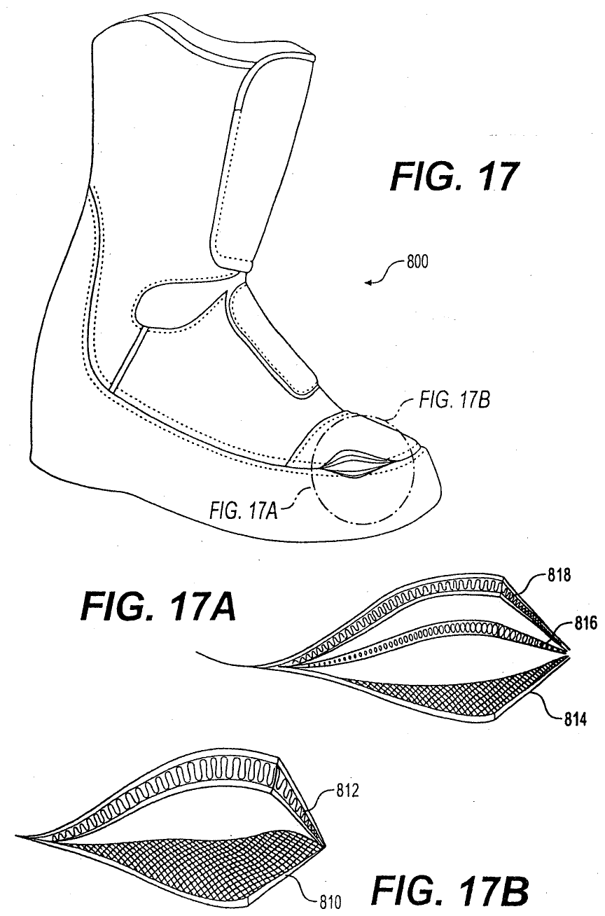

FIGS. 17, 17A and 17B illustrate an insert (800) for a soft shell alpine boot with first and second portion enlarged. 810 represents an outer shell fabric, a foam and a nonwoven composite. The 810 layer is preferably moldable antimicrobial thermal breathable, and transfers moisture. The 810 layer can be developed in a number of constructions. Layer 812 can be an outer shell fabric and a breathable foam, an outer shell fabric a breathable foam and a nonwoven, or an outer shell fabric and a cellular elastomeric composite, or outer shell fabric and a moisture transfer thermal with or without foam. Layer 812 is a spacer fabric, which can optionally be a breathable foam with or without a polymer mesh and silver fibers or fiber blends. Layer 812 can be optionally be a moisture transfer thermal moldable nonwoven composite, and in some performance categories the foam can be replaced with a cellular elastomeric composite included in the nonwoven layer. Layer 810 and layer 814 are similar to each other in this three-layer construction. Optionally, layer 814 can be a two-layer construction. Layer 814 illustrates a composite with an outer shell fabric and a foam, or an outer shell fabric and a nonwoven, or an outer shell fabric and a foam, or an outer shell fabric and a cellular elastomeric composite. Preferably layer 814 is an outer shell fabric and a moisture transfer thermal composite including breathable foam and silver fibers. Layer 816 is a moisture transfer thermal nonwoven inserted between the options in layer 814 and a spacer fabric in layer 818, or a foam with or without a polymer mesh. Optionally, layer 816 can be a foam nonwoven composite or a cellular elastomeric composite. This multi-layered composite abuts an inner lining material and forms the moldable liner insert or permanently attached liner. In some options, this liner may incorporate 3-15 layers. The spacer fabric in layer 818 can optionally be a foam a nonwoven or a combination. Layer 18 may also be a foam with a moldable polymer mesh.

FIGS. 18 and 18A illustrate a soft shell alpine boot (900) incorporating lining materials such as those shown in FIGS. 16 and 17. In the enlarged portion of FIG. 18, 820 illustrates an inner lining material. 822 illustrates a foam nonwoven composite and optionally 822 may be a cellular elastomeric composite or a breathable foam. Layer 824 illustrates a polymer mesh. The polymer mesh in 824 can be included in a foam, or in a nonwoven, or in a foam and nonwoven composite, or alternatively it may abut layers with any of these constructions. One option, layer 820 abuts a cellular elastomeric composite including a polymer mesh. Layer 826 illustrates another inner lining material. 826 may alternatively be a nonwoven and a cellular elastomeric composite or a knitted construction and a breathable foam or a three-layer composite composed of an inner lining material, a foam and a nonwoven. Preferably, the outer shell soft boot composite is composed of an outer shell fabric, a frothed open cell foam, a moisture transfer nonwoven, or nonwoven composite and an inner lining material. This composite is moldable, transfers moisture, and is thermal and waterproof.

FIGS. 19 and 19A illustrate a soft shell alpine boot (900) incorporating lining materials such as those shown in FIGS. 16 and 17. In the enlarged portion of FIG. 18, 830 illustrates an inner lining material. 832 illustrates a foam nonwoven composite and optionally 832 may be a cellular elastomeric composite or a breathable foam. Layer 834 illustrates another inner lining material. 834 may alternatively be a nonwoven and a cellular elastomeric composite or a knitted construction and a breathable foam or a three-layer composite composed of an inner lining material, a foam and a nonwoven. Preferably, the pouter shell soft boot composite is composed of an outer shell fabric, a frothed open cell foam, a moisture transfer nonwoven, or nonwoven composite and an inner lining material. This composite is moldable, transfers moisture, and is thermal and waterproof.

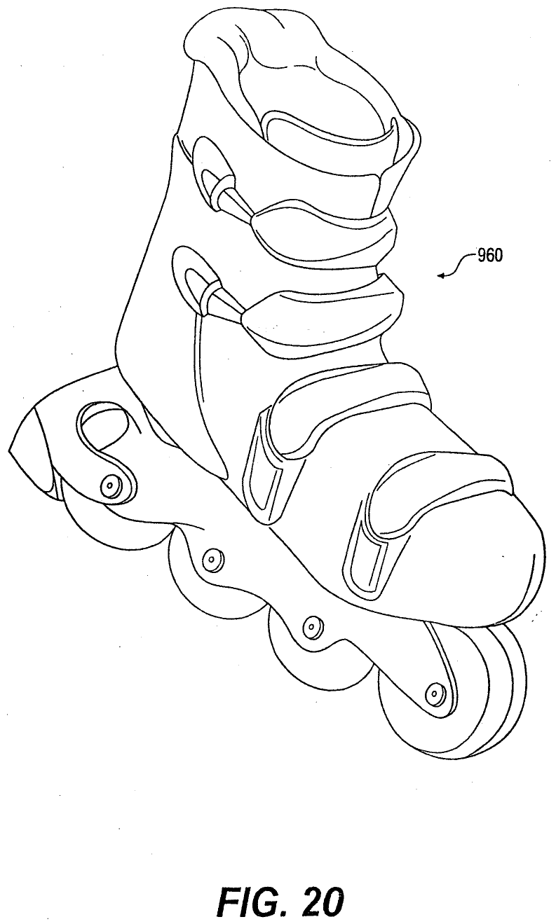

FIG. 20 illustrates a polymer shell for a hockey skate 960 including a moisture transfer liner.

FIG. 21 illustrates a soft shell inline skate (950) incorporating any of the insert materials of FIGS. 13-15. The soft shell inline skate does include some polymer shell materials identified as 920. Similar material also forms a part of the soft shell alpine boot of FIG. 18 although not explicitly identified. In some options, the polymer shell material in 920 can be eliminated from the soft alpine or skate boot, and in other options the shell material may be increased to provide more support.

All nonwovens, foams, fabrics, materials or composites can have fibers flocked to either one or both sides. The flocked fiber blend may include silver fibers by Foss Manufacturing Co.

While the present invention has been described above in connection with the preferred embodiments, one of ordinary skill in the art would be enabled by this disclosure to make various modifications to the disclosed embodiments and still be within the scope and spirit of the present invention as recited in the appended claims.

Any composite constructions or combination of composites in this application may be applied to technical apparel, casual sportswear, protective clothing, snowboard or biking helmets, accessories, in-line skates, ice skates, hockey skates, medical and may have industrial applications.

1. A composite lining, insert liner, soft-shell apparel, footwear or medical product comprising:
a first layer comprised of a breathable, moisture transfer, lining fabric or material;
a second layer comprised of a breathable, moisture transfer mechanically bonded, needle punch nonwoven material comprised of shaped, grooved and channeled synthetic polymer fibers, antimicrobial silver polymer fibers and thermal or cooling natural and synthetic fibers;
a third exterior shell layer comprised of an antimicrobial fabric or nonwoven material.

2. A composite lining, insert liner, soft-shell apparel, footwear or medical product according to claim 1, wherein the layers are attached by lamination, mechanically bonding, adhesive bonding or a combination thereof.

3. A composite lining, insert liner, soft-shell apparel, footwear or medical product according to claim 1, wherein the third exterior shell layer is a stretch woven or knitted fabric.

4. A composite lining, insert liner, soft-shell apparel, footwear or medical product according to claim 1, further comprising a moldable spacer fabric or open-cell foam material.

5. A composite lining, insert liner, soft-shell apparel, footwear or medical product according to claim 3, wherein the stretch woven or knitted fabric is water-resistant or waterproof.

6. A composite lining, insert liner, soft-shell apparel, footwear or medical product according to claim 1, wherein the third exterior shell layer is treated with nanotechnology.

7. A composite lining, insert liner, soft-shell apparel, footwear or medical product according to claim 1, wherein the second layer contains rayon, lyocel, wool, polyester cotton, kapok, acrylic, acetate, hemp, polypropylene, stretch fibers, hollow fibers, antimicrobial silver polymer fibers or a combination thereof.

8. A composite lining, insert liner, soft-shell apparel, footwear or medical product according to claim 7, wherein the third exterior shell layer is a stretch woven fabric or knitted fabric.

9. A composite lining, insert liner, soft-shell apparel, footwear or medical product according to claim 1, wherein the second layer includes deep grooved polymer fibers, acrylic fibers or a combination thereof.

10. A composite lining, insert liner, soft-shell apparel, footwear or medical product according to claim 9, further comprising a leather material.

11. A composite lining, insert liner, soft-shell apparel, footwear or medical product according to claim 9, wherein the second layer includes, stretch fibers, hollow fibers, rayon fibers, lyocell fibers or a combination thereof.

12. A composite lining, insert liner, soft-shell apparel, footwear or medical product according to claim 9, wherein the second layer is combined with a breathable foam.

13. A composite lining, insert liner, soft-shell apparel, footwear or medical product according to claim 10, wherein third exterior shell layer is treated with phase change technology, nanotechnology or a combination thereof.

14. A breathable, moisture transfer composite footwear, apparel or medical product comprising:
a first layer comprised of a breathable, moisture transfer lining fabric or material;
a second layer comprised of a breathable, moisture transfer, mechanically bonded, needle punch nonwoven material, the nonwoven material comprised of shaped, multi-grooved and channeled synthetic polymer fibers, antimicrobial silver polymer fibers and thermal or cooling natural and synthetic fibers;
a third exterior shell layer comprised of a water-resistant or waterproof knitted or woven fabric, leather material, nonwoven material or a combination thereof.

15. The breathable, moisture transfer composite footwear, apparel or medical product according to claim 14, wherein the third exterior shell layer is treated with nanotechnology, phase change material or a combination thereof.

16. The breathable, moisture transfer composite footwear, apparel or medical product according to claim 14, wherein the second layer is comprised of acrylic fibers.

17. The breathable, moisture transfer composite footwear, apparel or medical product according to claim 16, wherein the second layer is combined with a foam material.

18. The breathable, moisture transfer composite footwear, apparel or medical product according to claim 17, wherein the third exterior shell layer is treated with nanotechnology, phase change coating technology or a combination thereof.

19. The breathable, moisture transfer composite footwear, apparel or medical product according to claim 14, wherein the second layer is comprised of wool, lyocell, hollow fibers, rayon fibers, or a combination thereof.

20. A hot weather boot, alpine or snowboard boot, all-weather boot, hiking shoe, soft-shell apparel or medical product comprised of a series of material layers comprising:
a first layer of an absorbent, breathable, moisture transferring inner lining spacer fabric, knitted or woven fabric, nonwoven material or combination thereof;
a second layer mechanically bonded, breathable, moisture transferring, rapid dry, antimicrobial nonwoven material comprised of synthetic shaped fibers, antimicrobial silver polymer fibers and natural and synthetic thermal and/or cooling fibers providing adjustable thermal regulation; and
a third exterior layer comprised of a breathable woven fabric, knitted fabric, spacer fabric, nonwoven material, leather material or a combination thereof.
